(19) United States
(12) Patent Application Publication
(10) Pub. No.: US 2023/0422075 A1
(43) Pub. Date: Dec. 28, 2023

(54) LOCATION SERVICES FOR WIRELESS COMMUNICATION DEVICES

(71) Applicant: QUALCOMM Incorporated, San Diego, CA (US)

(72) Inventors: Hanna Lim, Seongnam-si (KR); Lenaig Genevieve Chaponniere, La Jolla, CA (US); Hong Cheng, Basking Ridge, NJ (US); Sunghoon Kim, San Diego, CA (US); Francesco Pica, San Diego, CA (US)

(21) Appl. No.: 18/170,427

(22) Filed: Feb. 16, 2023

Related U.S. Application Data
(60) Provisional application No. 63/338,778, filed on May 5, 2022.

(51) Int. Cl. H04W 28/02; H04W 64/00

(52) U.S. Cl. CPC H04W 28/0215; H04W 64/003

(57) ABSTRACT

Aspects relate to location services in a wireless communication network. A first wireless communication device may send capability information to the network indicating that the first wireless communication device supports a location services protocol but does not support location services notifications. Upon receiving this capability information, the network may refrain from performing a privacy check procedure directed to the first wireless communication device. As another example, the network may refrain from performing a privacy check procedure directed to the first wireless communication device based on a determination that the first wireless communication device performs a relay function (or otherwise does not support location services notifications or user interaction). As yet another example, the network may determine, based on a privacy profile of the first wireless communication device, that the first wireless communication device is a type of device that is not associated with privacy checks.

### CROSS-REFERENCE TO RELATED APPLICATIONS

The present application for patent claims priority to and the benefit of pending U.S. Provisional Application No. 63/338,778, titled “LOCATION SERVICES FOR WIRELESS COMMUNICATION DEVICES” filed May 5, 2022, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to location services for identifying the location of a wireless communication device.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple wireless communication devices. For example, a base station may allocate different resources (e.g., time domain and frequency domain resources) for different wireless communication devices operating within a cell of the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first wireless communication device may include a transceiver and a processor coupled to the transceiver. The processor may be configured to transmit capability information to a network entity via the transceiver. In some examples, the capability information indicates support for a location services protocol and an absence of support for location services notifications. The processor may also be configured to receive, via the transceiver, first signaling associated with a first location request directed to the first wireless communication device. The processor may further be configured to transmit second positioning signaling.

In some examples, a method for wireless communication at a first wireless communication device is disclosed. The method may include transmitting capability information to a network entity. In some examples, the capability information indicates support for a location services protocol and an absence of support for location services notifications. The method may also include receiving first signaling associated with a first location request directed to the first wireless communication device. The method may further include transmitting second positioning signaling.

In some examples, a first wireless communication device may include means for transmitting capability information to a network entity. In some examples, the capability information indicates support for a location services protocol and an absence of support for location services notifications. The first wireless communication device may also include means for receiving first signaling associated with a first location request directed to the first wireless communication device. The first wireless communication device may further include means for transmitting second positioning signaling.

In some examples, a non-transitory computer-readable medium has stored therein instructions executable by a processing system of a first wireless communication device to transmit capability information to a network entity. In some examples, the capability information indicates support for a location services protocol and an absence of support for location services notifications. The computer-readable medium may also have stored therein instructions executable by the processing system of the first wireless communication device to receive first signaling associated with a first location request directed to the first wireless communication device. The computer-readable medium may further have stored therein instructions executable by the processing system of the first wireless communication device to transmit second positioning signaling.

In some examples, a network entity may include a communication interface, and a processor coupled to the communication interface. The processor may be configured to receive capability information from a first wireless communication device via the communication interface. In some examples, the capability information indicates support for a location services protocol and an absence of support for location services notifications. The processor may also be configured to transmit a first location request via the communication interface while abstaining from performing a privacy check procedure associated with the first location request responsive to the capability information indicating the absence of support for the location services notifications. In some examples, the first location request may request a location of the first wireless communication device. The processor may further be configured to receive an indication of the location of the first wireless communication device via the communication interface.

In some examples, a method for communication at a network entity is disclosed. The method may include receiving capability information from a first wireless communication device. In some examples, the capability information indicates support for a location services protocol and an absence of support for location services notifications. The method may also include transmitting a first location request while abstaining from performing a privacy check procedure associated with the first location request responsive to the capability information indicating the absence of support for the location services notifications. In some examples, the first location request may request a location of the first wireless communication device. The method may further include receiving an indication of the location of the first wireless communication device.

In some examples, a network entity may include means for receiving capability information from a first wireless communication device. In some examples, the capability information indicates support for a location services protocol and an absence of support for location services notifications. The network entity may also include means for transmitting a first location request while abstaining from performing a privacy check procedure associated with the first location request responsive to the capability information indicating the absence of support for the location services notifications. In some examples, the first location request may request a location of the first wireless communication device. The network entity may further include means for receiving an indication of the location of the first wireless communication device.

In some examples, a non-transitory computer-readable medium has stored therein instructions executable by a processing system of a network entity to receive capability information from a first wireless communication device. In some examples, the capability information indicates support for a location services protocol and an absence of support for location services notifications. The computer-readable medium may also have stored therein instructions executable by the processing system of the network entity to transmit a first location request while abstaining from performing a privacy check procedure associated with the first location request responsive to the capability information indicating the absence of support for the location services notifications. In some examples, the first location request may request a location of the first wireless communication device. The computer-readable medium may further have stored therein instructions executable by the processing system of the network entity to receive an indication of the location of the first wireless communication device.

In some examples, a network entity may include a communication interface, and a processor coupled to the communication interface. The processor may be configured to receive capability information from a first wireless communication device via the communication interface. In some examples, the capability information indicates support for a location services protocol and support for location services notifications. The processor may also be configured to receive subscription data associated with the first wireless communication device via the communication interface. The processor may further be configured to transmit a first location request via the communication interface while abstaining from performing a privacy check procedure associated with the first location request responsive to the subscription data indicating that the first wireless communication device is a first type of user equipment. In some examples, the first location request may request a location of the first wireless communication device. The processor may additionally be configured to receive an indication of the location of the first wireless communication device via the communication interface.

In some examples, a method for communication at a network entity is disclosed. The method may include receiving capability information from a first wireless communication device. In some examples, the capability information indicates support for a location services protocol and support for location services notifications. The method may also include receiving subscription data associated with the first wireless communication device. The method may further include transmitting a first location request while abstaining from performing a privacy check procedure associated with the first location request responsive to the subscription data indicating that the first wireless communication device is a first type of user equipment. In some examples, the first location request may request a location of the first wireless communication device. The method may additionally include receiving an indication of the location of the first wireless communication device.

In some examples, a network entity may include means for receiving capability information from a first wireless communication device. In some examples, the capability information indicates support for a location services protocol and support for location services notifications. The network entity may also include means for receiving subscription data associated with the first wireless communication device. The network entity may further include means for transmitting a first location request while abstaining from performing a privacy check procedure associated with the first location request responsive to the subscription data indicating that the first wireless communication device is a first type of user equipment. In some examples, the first location request may request a location of the first wireless communication device. The network entity may additionally include means for receiving an indication of the location of the first wireless communication device.

In some examples, a non-transitory computer-readable medium has stored therein instructions executable by a processing system of a network entity to receive capability information from a first wireless communication device. In some examples, the capability information indicates support for a location services protocol and support for location services notifications. The computer-readable medium may also have stored therein instructions executable by the processing system of the network entity to receive subscription data associated with the first wireless communication device. The computer-readable medium may further have stored therein instructions executable by the processing system of the network entity to transmit a first location request while abstaining from performing a privacy check procedure associated with the first location request responsive to the subscription data indicating that the first wireless communication device is a first type of user equipment. In some examples, the first location request may request a location of the first wireless communication device. The computer-readable medium may additionally have stored therein instructions executable by the processing system of the network entity to receive an indication of the location of the first wireless communication device.

In some examples, a network entity may include a communication interface, and a processor coupled to the communication interface. The processor may be configured to receive subscription data associated with a first wireless communication device via the communication interface. In some examples, the subscription data includes a first indication associated with a privacy check. The processor may also be configured to transmit a first location request via the communication interface. In some examples, the first location request may request a location of the first wireless communication device.

In some examples, the first location request includes a second indication that a privacy check procedure is not required for the first location request. The processor may further be configured to receive a third indication of the location of the first wireless communication device via the communication interface.

In some examples, a method for communication at a network entity is disclosed. The method may include receiving subscription data associated with a first wireless communication device. In some examples, the subscription data includes a first indication associated with a privacy check. The method may also include transmitting a first location request. In some examples, the first location request may request a location of the first wireless communication device. In some examples, the first location request includes a second indication that a privacy check procedure is not required for the first location request. The method may further include receiving a third indication of the location of the first wireless communication device.

In some examples, a network entity may include means for receiving subscription data associated with a first wireless communication device. In some examples, the subscription data includes a first indication associated with a privacy check. The network entity may also include means for transmitting a first location request. In some examples, the first location request may request a location of the first wireless communication device. In some examples, the first location request includes a second indication that a privacy check procedure is not required for the first location request. The network entity may further include means for receiving a third indication of the location of the first wireless communication device.

In some examples, a non-transitory computer-readable medium has stored therein instructions executable by a processing system of a network entity to receive subscription data associated with a first wireless communication device. In some examples, the subscription data includes a first indication associated with a privacy check. The computer-readable medium may also have stored therein instructions executable by the processing system of the network entity to transmit a first location request. In some examples, the first location request may request a location of the first wireless communication device. In some examples, the first location request includes a second indication that a privacy check procedure is not required for the first location request. The computer-readable medium may further have stored therein instructions executable by the processing system of the network entity to receive a third indication of the location of the first wireless communication device.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of wireless resources in an air interface utilizing orthogonal frequency divisional multiplexing (OFDM) according to some aspects.

FIG. 4 is a diagram illustrating an example of a network configuration including an integrated access backhaul (IAB) network according to some aspects.

FIG. 5 is a diagram illustrating an example of IAB node functionality within an IAB network according to some aspects.

FIG. 6 is a schematic illustration of a wireless communication system supporting location services according to some aspects.

FIGS. 7A and 7B are a signaling diagram illustrating an example of signaling associated with location services according to some aspects.

FIG. 8 is a conceptual illustration of a wireless communication system employing assisting nodes according to some aspects.

FIG. 9 is a schematic illustration of an example of a repeater according to some aspects.

FIG. 10 is a schematic illustration of another example of a repeater according to some aspects.

FIG. 11 is a conceptual illustration of protocol layers according to some aspects.

FIG. 12 is a conceptual illustration of an example of an information element according to some aspects.

FIG. 13 is a signaling diagram illustrating an example of signaling associated with location services capability information according to some aspects.

FIG. 14 is a signaling diagram illustrating an example of signaling associated with abstaining from performing a privacy check procedure according to some aspects.

FIG. 15 is a conceptual illustration of an example of a privacy profile according to some aspects.

FIG. 16 is a signaling diagram illustrating an example of signaling associated with abstaining from performing a privacy check procedure according to some aspects.

FIG. 17 is a block diagram conceptually illustrating an example of a hardware implementation for a wireless communication device (e.g., a mobile relay) employing a processing system according to some aspects.

FIG. 18 is a flow chart illustrating an example communication method relating to location services capability information according to some aspects.

FIG. 19 is a block diagram conceptually illustrating an example of a hardware implementation for a network entity (e.g., an access and mobility management function) employing a processing system according to some aspects.

FIG. 20 is a flow chart illustrating an example communication method relating to abstaining from performing a privacy check procedure according to some aspects.

FIG. 21 is a flow chart illustrating another example communication method relating to abstaining from performing a privacy check procedure according to some aspects.

FIG. 22 is a block diagram conceptually illustrating an example of a hardware implementation for a network entity (e.g., a gateway mobile location center) employing a processing system according to some aspects.

FIG. 23 is a flow chart illustrating another example communication method relating to abstaining from performing a privacy check procedure according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to location services. For example, a location services client may send a request to a network for the location of a user equipment. In some examples, a privacy attribute associated with the user equipment may dictate whether a particular location services client is allowed to obtain the location of the user equipment. In this case, the network may perform a privacy check procedure to determine whether the network is allowed to send the location of the user equipment to a requesting location services client.

In some examples, a first wireless communication device (e.g., a mobile relay) may forward location services information received from a network entity to a user equipment and/or forward location services information received from a user equipment to a network entity. In some examples, the first wireless communication device may have one or more attributes of (e.g., functionality of) a user equipment in the network. Thus, a location services client could request the location of the first wireless communication device. However, the first wireless communication device might not support a privacy check (e.g., the first wireless communication device simply provides a relay function). Consequently, the use of an unnecessary privacy check procedure directed to the first wireless communication device may waste valuable resources and/or adversely affect latency performance of the first wireless communication device.

In some examples, a network may be prevented from performing a privacy check procedure for a first wireless communication device (e.g., a mobile relay). For example, the first wireless communication device may send capability information to the network indicating that the first wireless communication device supports a location services protocol but does not support location services notifications. Upon receiving this capability information, the network may refrain from performing a privacy check procedure directed to the first wireless communication device. As another example, the network may refrain from performing a privacy check procedure directed to the first wireless communication device based on a determination that the first wireless communication device performs a relay function (or otherwise does not support location services notifications or user interaction). As yet another example, the network may determine, based on a privacy profile of the first wireless communication device, that the first wireless communication device is a type of device that is not associated with privacy checks. As a further another example, the network may determine, based on subscription data, whether a user is involved with a location services privacy check or whether the first wireless communication device is allowed for mobile relay operation.

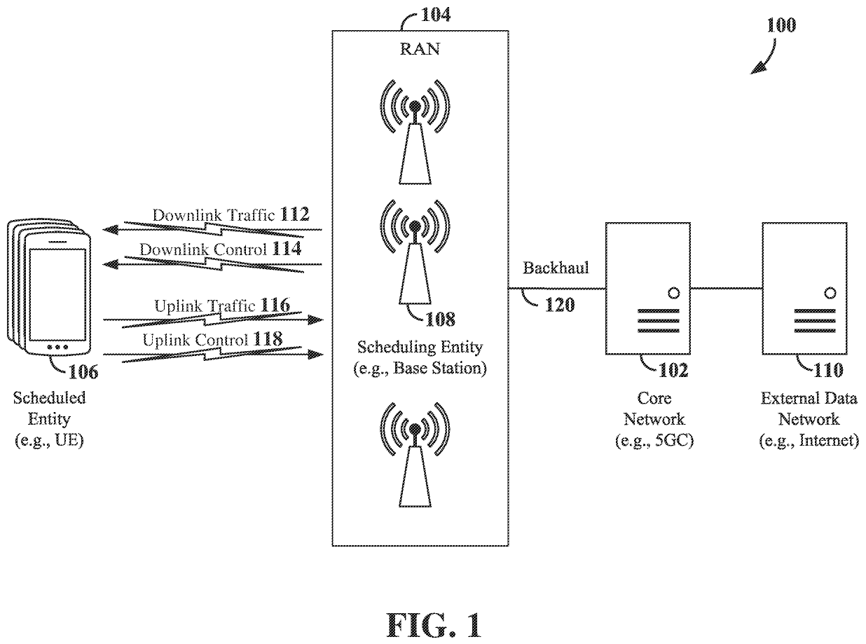

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant quality of service (QoS) for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

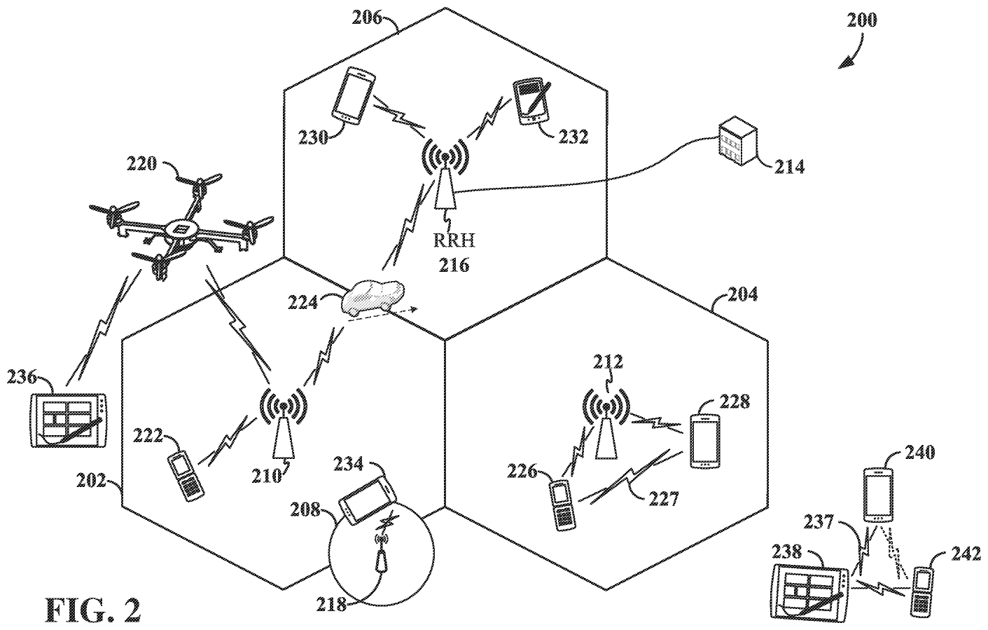

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

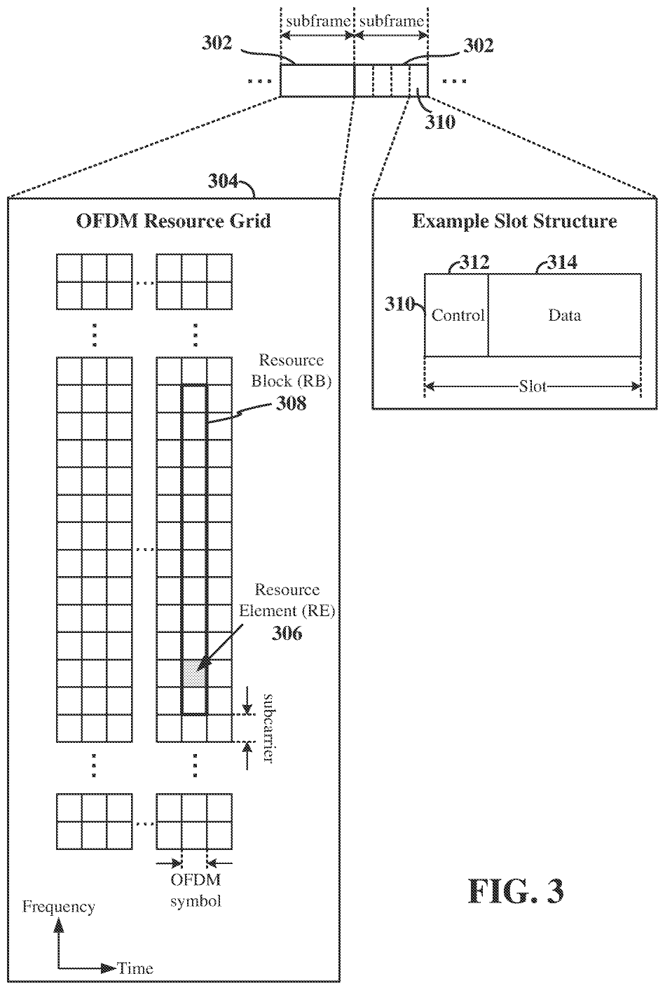

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time—frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time—frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

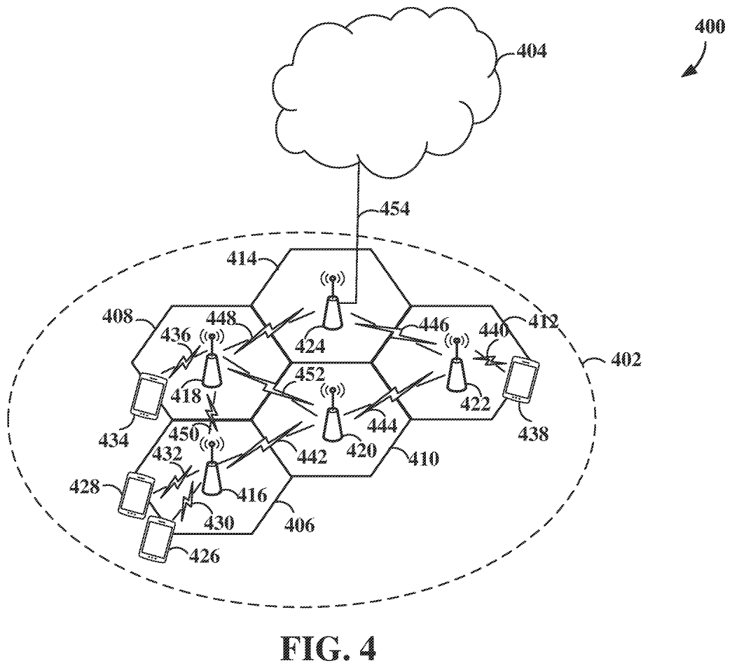

FIG. 4 is a schematic diagram providing a high-level illustration of one example of an integrated access backhaul (IAB) network configuration 400 that may be utilized in some examples. In this illustration, an IAB network 402, is coupled to a remote network 404, such as a main backhaul network or mobile core network. In such an IAB network 402, the wireless spectrum may be used for both access links and backhaul links. In some examples, the wireless spectrum may utilize millimeter-wave (mmWave) or sub-6 GHz carrier frequencies.

The IAB network 402 may be similar to the radio access network 200 shown in FIG. 2, in that the IAB network 402 may be divided into a number of cells 406, 408, 410, 412, and 414, each of which may be served by a respective IAB node 416, 418, 420, 422, and 424. Each of the IAB nodes 416-424 may be an access point, base station (BS), eNB, gNB, or other node that utilizes wireless spectrum (e.g., the radio frequency (RF) spectrum) to support access for one or more UEs located within the cells 406-414 served by the IAB nodes.

In the example shown in FIG. 4, IAB node 416 communicates with UEs 426 and 428 via wireless access links 430 and 432, IAB node 418 communicates with UE 434 via wireless access link 436, and IAB node 422 communicates with UE 438 via wireless access link 440. The IAB nodes 416-424 are further interconnected via one or more wireless backhaul links 442, 444, 446, 448, 450, and 452. Each of the wireless backhaul links 442-452 may utilize the same wireless spectrum (e.g., the radio frequency (RF) spectrum) as the access links 430-440 to backhaul access traffic to/from the remote network 404. This may be referred to as wireless self-backhauling. Such wireless self-backhauling can enable fast and easy deployment of highly dense small cell networks. That is, rather than requiring each new gNB deployment to be outfitted with its own hard-wired backhaul connection, the wireless spectrum utilized for communication between the gNB and UE may be leveraged for backhaul communication between any numbers of IAB nodes to form the IAB network 402.

In the example shown in FIG. 4, IAB node 416 communicates with IAB node 420 via wireless backhaul link 442, IAB node 420 communicates with IAB node 422 via wireless backhaul link 444, IAB node 422 communicates with IAB node 424 via wireless backhaul link 446, IAB node 424 communicates with IAB node 418 via wireless backhaul link 448, IAB node 418 communicates with IAB node 416 via wireless backhaul link 450, and IAB node 418 communicates with IAB node 420 via wireless backhaul link 452. As shown in FIG. 4, each IAB node 416-424 may be connected via respective wireless backhaul links 442-452 to two or more other IAB nodes for robustness.

Some or all of the IAB nodes 416-424 may also be connected via wired backhaul links (e.g., fiber, coaxial cable, Ethernet, copper wires, etc.) and/or microwave backhaul links. Thus, the IAB network 402 may support both wired/microwave and wireless backhaul traffic. At least one of the IAB nodes (e.g., IAB node 424) may be a border IAB node, also referred to herein as an IAB donor node, that also provides a communication link 454 to the remote network 404. For example, the IAB donor node 424 may include a wired (e.g., fiber, coaxial cable, Ethernet, copper wires), microwave, or other suitable link 454 to the remote network 404.

To facilitate wireless communication between the IAB nodes 416-424 and between the IAB nodes 416-424 and the UEs served by the IAB nodes 416-424, each IAB node 416-424 may be configured to operate as both a scheduling entity and a scheduled entity. Thus, an IAB node (e.g., IAB node 416) may utilize the same wireless spectrum to transmit access traffic to/from UEs and to then backhaul that access traffic to/from the remote network 404. For example, to backhaul access traffic to/from the IAB node 418, IAB node 418 may communicate with IAB node 420 to transmit backhaul access traffic via wireless backhaul link 442, IAB node 420 may communicate with IAB node 422 to transmit the backhaul access traffic via wireless backhaul link 444, and IAB node 422 may communicate with IAB node 424 to transmit the backhaul access traffic via wireless backhaul link 446. In this example, IAB nodes 420 and 422 may each operate as both a scheduling entity and a scheduled entity to backhaul access traffic to/from the IAB node 416. As such, communication between a pair of IAB nodes may be individually scheduled by one of the IAB nodes within the pair.

In other examples, an IAB node may schedule wireless backhaul communications between other pairs of IAB nodes. For example, IAB node 424 may operate as the scheduling entity for the TAB network 402, while TAB nodes 416, 420, and 422 each operate as a scheduled entity to backhaul access traffic to/from the TAB node 416. In this example, TAB node 424 may schedule wireless backhaul communications between each of the pairs of TAB nodes (e.g., between TAB node 416 and TAB node 420, between TAB node 420 and TAB node 422, and between TAB node 422 and TAB node 424). As another example, TAB node 422 may operate as a scheduling entity to schedule wireless backhaul communications between TAB nodes 416 and 420 and also between TAB node 420 and TAB node 422. TAB node 422 may then operate as a scheduled entity to allow TAB node 424 to schedule wireless backhaul communications therebetween.

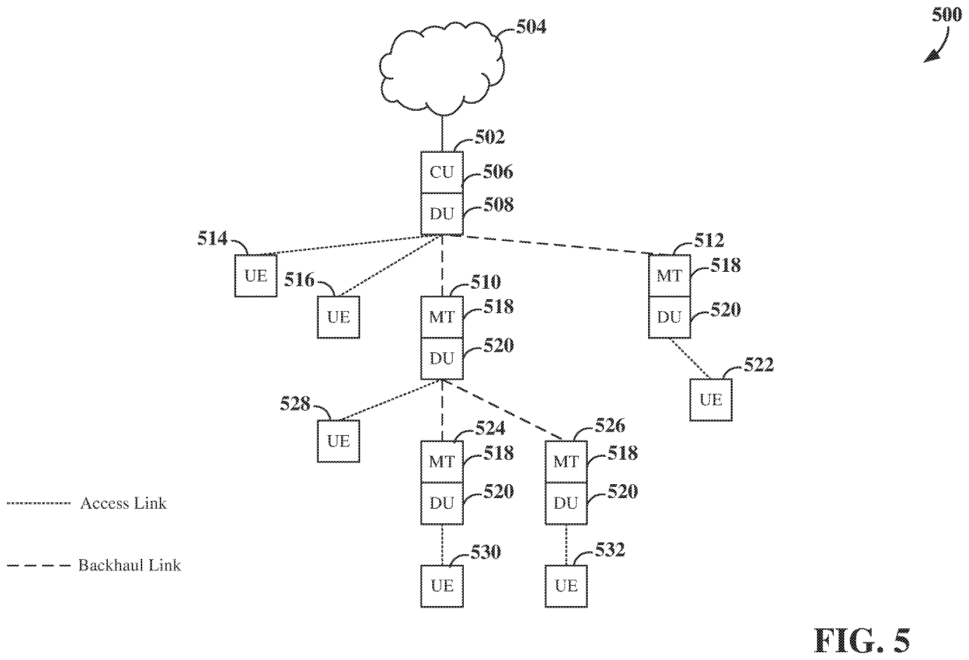

FIG. 5 is a schematic diagram illustrating an example of TAB node functionality within an TAB network 500. In the example shown in FIG. 5, an TAB node 502 is shown coupled to a core network 504 via a wireline connection. This TAB node 502 may be referred to herein as an TAB donor node, which may be, for example, an enhanced gNB including functionality for controlling the TAB network 500. In some examples, the TAB donor node 502 may include a central unit (CU) 506 and a distributed unit (DU) 508. The CU 506 is configured to operate as a centralized network node (or central entity) within the TAB network 500. For example, the CU 506 may include radio resource control (RRC) layer functionality and packet data convergence protocol (PDCP) layer functionality to control/configure the other nodes (e.g., TAB nodes and UEs) within the TAB network 500. In some aspects, RRC signaling may be used for various functions including, as one example, setting up and releasing user data bears. In some examples, RRC signaling messages may be transported over signaling radio bearers (e.g., signal radio bearer (SRB) 1 and SRB 2).

The DU 508 is configured to operate as a scheduling entity to schedule scheduled entities (e.g., other TAB nodes and UEs) of the TAB donor node 502. For example, the DU 508 of the TAB donor node 502 may operate as a scheduling entity to schedule TAB nodes 510 and 512 and UEs 514 and 516. Thus, the DU 508 of the TAB donor node 502 may schedule communication with TAB nodes 510 and 512 via respective backhaul links and schedule communication with UEs 514 and 516 via respective access links. In some examples, the DU 508 may include the radio link control (RLC), medium access control (MAC), and physical (PHY) layer functionality to enable operation as a scheduling entity.

Each of the TAB nodes 510 and 512 may be configured as a Layer 2 (L2) relay node including a respective DU 520 and a mobile termination (MT) unit 518 to enable each L2 relay TAB node 510 and 512 to operate as a scheduling entity and a scheduled entity. For example, the MT unit 518 within each of the L2 relay TAB nodes 510 and 512 is configured to operate as a scheduled entity that may be scheduled by the TAB donor node 502. Each MT unit 518 within the L2 relay TAB nodes 510 and 512 further facilitates communication with the TAB donor node 502 via respective backhaul links. In addition, the DU 520 within each of the L2 relay TAB nodes 510 and 512 operates similar to the DU 508 within the TAB donor node 502 to function as a scheduling entity to schedule one or more respective scheduled entities (e.g., other TAB nodes and/or UEs) of the L2 relay TAB nodes 510 and 512.

For example, the DU 520 of L2 relay TAB node 512 functions as a scheduling entity to schedule communication with a UE 522 via an access link, while the DU 520 of L2 relay TAB node 510 functions as a scheduling entity to schedule communication with the MT units 518 of L2 relay TAB nodes 526 and 526 via respective backhaul links and a UE 528 via an access link. Each of the L2 relay TAB nodes 524 and 526 further includes a respective DU 520 that functions as a scheduling entity to communicate with respective UEs 530 and 532. Thus, in the network topology illustrated in FIG. 5, since TAB donor node 502 is configured to control each of the other nodes in the TAB network, the TAB donor node 502 is a parent TAB node of child TAB nodes 510, 512, 524 and 526. In addition, TAB node 510 is further a parent TAB node of child TAB nodes 524 and 526. For example, the CU 506 and DU 508 within TAB donor node 502 may function as the parent TAB node of child TAB nodes 510, 512, 524, and 526 and the DU 520 within TAB node 510 may function as the parent TAB node of child TAB nodes 524 and 526. The MT unit 518 within TAB nodes 510, 512, 524, and 526 may further function as child TAB nodes.

In a mobile TAB network, one or more of the L2 relay TAB nodes 510, 512, 524, and/or 526 may be moving within the TAB network 500. For example, an L2 relay TAB node (e.g., TAB node 524) may be a mobile TAB node installed on a bus, train, taxi, platooned vehicle, or other moveable object.

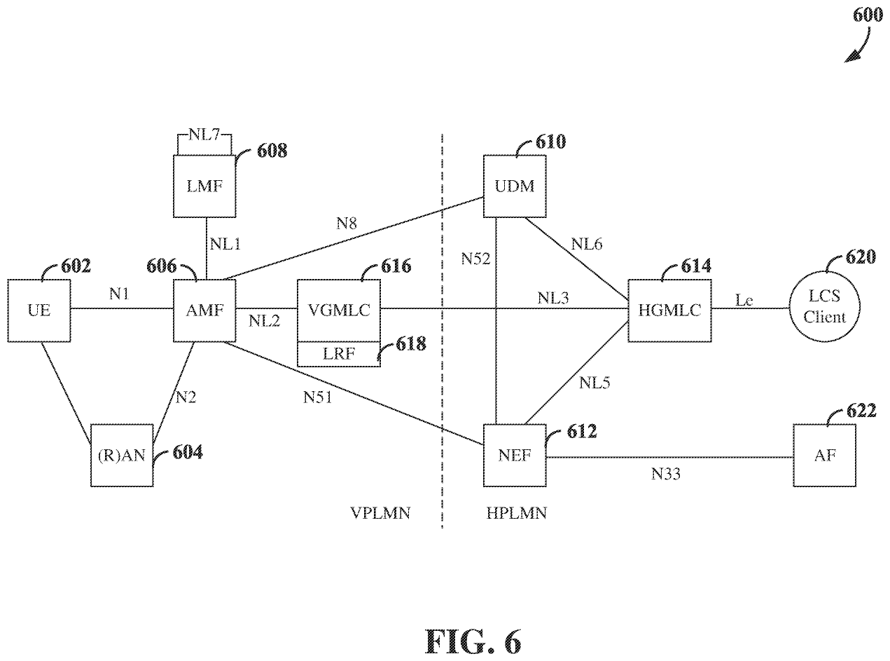

FIG. 6 illustrates an example of a 5G wireless communication system (5GS) 600 that supports location services (LCS) for LCS clients. In some examples, an LCS Client may be a software and/or hardware entity that interacts with an LCS Server for the purpose of obtaining location information (e.g., geographic location, cell information, service area information, tracking area information, etc.) for one or more UEs. LCS Clients subscribe to LCS to obtain location information. LCS Clients may or may not interact with human users. The LCS Client is responsible for formatting and presenting data and managing the user interface (dialogue). In some examples, the 5GS 600 may be the wireless communication system 100 described above and illustrated in FIG. 1. The 5GS 600 includes a UE 602 and a next generation radio access network (NG-RAN) 604. In the example of FIG. 6, the NG-RAN 604 connects to a 5G core network. In other examples, trusted non-3GPP access or untrusted non-3GPP access could be used in place of the NG-RAN 604.

The 5G core network may include, for example, an access and mobility management function (AMF) 606, a session management function (not shown), and a location management function (LMF) 608.

The AMF 606 employs control plane (e.g., Non Access Stratum (NAS)) signaling to perform various functions related to mobility management and session management for the UE 602. For example, the AMF 606 provides connectivity, mobility management, and authentication of the UE 602. In some examples, the AMF 606 includes a co-located security anchor function (SEAF) that allows for re-authentication of a UE 602 when the UE moves between different NG-RANs 604 without having to perform a complete authentication. The AMF 606 includes functionality responsible for managing positioning for a target UE for all types of location requests. The AMF is accessible to a gateway mobile location center (GMLC) and a network exposure function (NEF) via an Namf interface, to the RAN via an N2 reference point, and to the UE via an N1 reference point.

The LMF 608 manages the overall co-ordination and scheduling of resources required for the location of a UE that is registered with or accessing the 5GC 600. The LMF 608 also calculates or verifies a final location and any velocity estimate and may estimate the achieved accuracy. The LMF 608 receives location requests for a target UE from the serving AMF using an Nlmf interface. The LMF 608 interacts with the UE to exchange location information applicable to UE assisted and UE based position methods and interacts with the NG-RAN to obtain location information.

The 5G core network may include other functions, such as a GMLC function, and a location retrieval function (LRF) 618. In the roaming architecture of FIG. 6, the GMLC function is divided between a home GMLC (HGMLC) 614 and a visited GMLC (VGMLC) 616. An HGMLC is the GMLC residing in the target UE's home public land mobile network (PLMN), which is responsible for the control of privacy checking of the target UE. A VGMLC is the GMLC that is associated with the serving node of the target UE.

In some examples, the GMLC function is a control plane system that interfaces with emergency and commercial LCS clients and the operator's network to provide the location of a mobile device, required to support Location Based Services (LBS). A GMLC is the first node an external LCS client accesses in a PLMN (i.e., the Le reference point is supported by the GMLC). Application Functions (AFs) and Network Functions (NFs) may access a GMLC directly or via an NEF. The GMLC may request routing information and/or target UE privacy information from the unified data management (UDM) via an Nudm interface. After performing authorization of an external LCS Client or AF and verifying target UE privacy, a GMLC forwards a location request to either a serving AMF using the Namf interface or to a GMLC in another PLMN using an Ngmlc interface in the case of a roaming UE. An HGMLC is the GMLC residing in the target UE's home PLMN, which is responsible for the control of privacy checking of the target UE. A VGMLC is the GMLC that is associated with the serving node of the target UE.

The LRF 618 may be collocated with a GMLC or separate from a GMLC. In some examples, the LRF 618 is responsible for retrieving or validating location information, providing routing and/or correlation information for a UE which has initiated an Internet Protocol (IP) multimedia subsystem (IMS) emergency session.

The 5G core network may include other functions, such as a UDM 610, a network exposure function (NEF) 612, and other functions (not illustrated, for simplicity).

In some examples, the UDM 610 facilitates the generation of authentication and key agreement (AKA) credentials, performs user identification, and manages subscription information and UE context. The UDM 610 may contain LCS subscriber, LCS privacy profile, and routing information. The UDM 610 may be accessible from an AMF, a GMLC, or an NEF via the Nudm interface.

The NEF 612 provides a means of accessing location services by an application function 622 (e.g., an external AF or an internal AF). AFs access location services from an NEF using an application interface (API). Depending on QoS requirements, an NEF can forward a location request to a GMLC or request an event exposure for location information from a serving AMF (optionally via a UDM). When event exposure via AMF is used, an NEF may request routing information and/or target UE privacy information from the UDM via the Nudm interface.

An LCS client 620 may communicate with the GMLC functions to request the location of the UE 602. For example, the LCS client may send a location request to the HGMLC 614 which forwards the location request to the VGMLC 616. The VGMLC 616, in turn, forwards the location request to the AMF 606 which, determines whether the LCS client 620 is allowed to obtain the location of the UE 602.

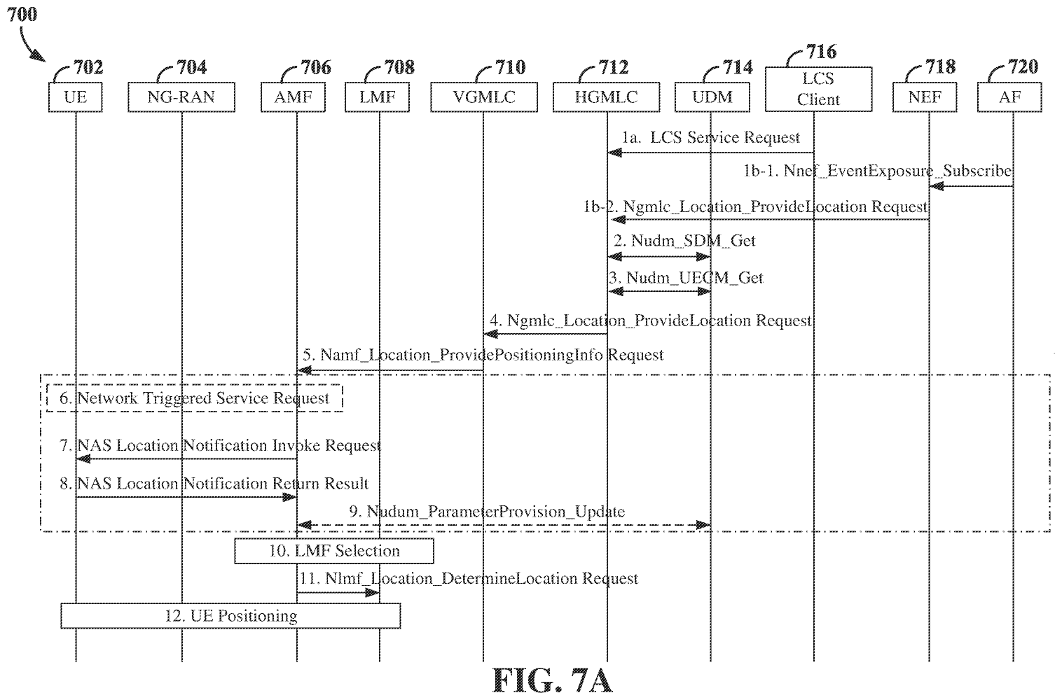

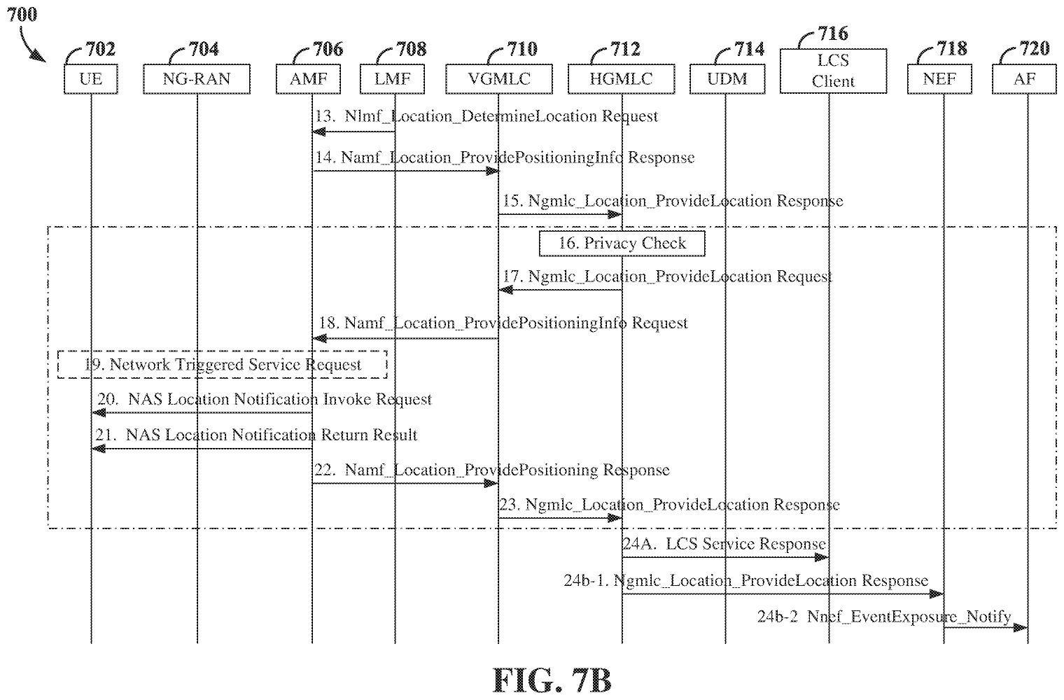

FIGS. 7A and 7B illustrate an example of LCS-related signaling 700 in a wireless communication system (e.g., the 5GS 600 of FIG. 6) that includes a UE 702, an NG-RAN 704, an AMF 706, an LMF 708, a (V)GMLC 710, an (H)GMLC 712, a UDM 714, an LCS client 716, an NEF 718, and an AF 720.

An LCS client or an application function (AF) may or may not be authorized to retrieve the UE location, e.g., for commercial use. UE LCS privacy is a feature which allows a UE and/or AF to control which LCS clients and Afs are allowed/not allowed access to UE location information. UE LCS privacy can be supported via subscription and via UE LCS privacy profile handling.

At Step 1 of FIG. 7A, the LCS Client 716 or the AF 720 (via the NEF 718) sends a request to the (H)GMLC 712 for a location and optionally a velocity for the target UE which may be identified by a Generic Public Subscription Identifier (GPSI) or a Subscription Permanent Identifier (SUPI). The request may include the required QoS, supported geographical area description (GAD) shapes, and other attributes. The (H)GMLC 712 (for Step 1a) or NEF 718 (for Step 1b) authorizes the LCS Client 716 or the AF 720 for the usage of the LCS service. If the authorization fails, Steps 2-23 are skipped and the (H)GMLC 712 (for Step 1a) or the NEF 718 (for Step 1b) responds to the LCS Client 716 or the AF 720 indicating the failure of the service authorization in Step 24. In some cases, the (H)GMLC 712 derives the GPSI or SUPI of the target UE 702 and possibly the QoS from either subscription data or other data supplied by the LCS Client 716 or the AF 720.

At Step 1b-1, the AF 720 sends the Nnef EventExposure Subscribe to the NEF 718. At Step 1b-2, the NEF 718 identifies, based on the QoS attribute received from the location request, that higher than cell-ID level location accuracy is required and invokes the Ngmlc Location ProvideLocation Request service operation to the (H)GMLC 712, which contains the attributes received from the AF request. The NEF 718 may also invoke the Ngmlc Location ProvideLocation Request service operation to the (H)GMLC 712 for lower than cell-ID location accuracy as an implementation option or if a scheduled location time is included.

At Step 2, the (H)GMLC 712 invokes a Nudm SDM Get service operation towards the UDM 714 of the target UE 702 to get the privacy settings of the UE 702 identified by its GPSI or SUPI. The UDM 714 returns the target UE Privacy setting of the UE 702. The (H)GMLC 712 checks the UE LCS privacy profile. If the target UE 702 is not allowed to be located, Steps 3-23 are skipped.

At Step 3, the (H)GMLC 712 invokes a Nudm UECM Get service operation towards the UDM 714 of the target UE 702 with the GPSI or SUPI of the UE 702. The UDM 714 returns the network addresses of the current serving AMF 706 and additionally the address of a VGMLC 710 (for roaming case). If the location request is an immediate location request, the (H)GMLC 712 checks the country codes of the serving node addresses. If the (H)GMLC 712 finds the current AMF 706 is out of the service coverage of the (H)GMLC 712, the (H)GMLC 712 returns an appropriate error message to the LCS client 716 or the AF 720 (via the NEF 718).

For a non-roaming case, Step 4 is skipped. In the case of roaming, at Step 4 the HGMLC 712 may receive an address of a VGMLC 710 (together with the network address of the current serving AMF 706) from the UDM 714 in Step 3, otherwise, the HGMLC 712 may use the network repository function (NRF) service in the home PLMN (HPLMN) to select an available VGMLC in the visited PLMN (VPLMN), based on the VPLMN identification contained in the AMF address received in Step 3. The HGMLC 712 then sends the location request to the VGMLC 710 by invoking the Ngmlc Location ProvideLocation service operation towards the VGMLC 710. In the cases when the HGMLC 712 did not receive the address of the VGMLC 710, or when the VGMLC address is the same as the HGMLC address, or when both PLMN operators agree, the HGMLC 712 sends the location service request message to the serving AMF 706. In this case, Step 4 is skipped. If the result of the privacy check indicates that verification based on current location is needed, the HGMLC 712 shall send a location request to the VGMLC 710 (in the case of roaming) or to the AMF 706 (in the case of non-roaming) indicating “positioning allowed without notification” and the VGMLC 710 shall invoke an Namf Location ProvidePositioninglnfo Request service operation towards the AMF 706 at Step 5. The HGMLC 712 also provides the LCS client type of AF, if received, or LCS client type of LCS client and other attributes to be sent to the AMF 706 in Step 5.

In the case of roaming, at Step 5, the VGMLC 710 first authorizes that the location request is allowed from this HGMLC, PLMN, or from this country. If not, an error response is returned. The (H)GMLC 712 or VGMLC 710 invokes the Namf Location ProvidePositioninglnfo service operation towards the AMF 706 to request the current location of the UE 702. The service operation includes the SUPI, the client type, and may include the required LCS QoS, supported GAD shapes, scheduled location time, service type, and other attributes as received or determined in Step 1.

At Step 6, if the UE 702 is in Connection Management (CM) IDLE state, the AMF 706 initiates a network triggered Service Request procedure as defined in clause 4.2.3.3 of 3GPP Technical Specification (TS) 23.502 to establish a signaling connection with the UE 702. If signaling connection establishment fails, Steps 7-13 are skipped and the AMF 706 answers to the GMLC in Step 14 with the last known location of the UE (i.e., Cell ID) together with the age of this location.

At Steps 7-9, a privacy check is performed to determine whether the LCS client 716 is allowed to obtain the location of the UE 702.

At Step 7, if the indicator of privacy check related action indicates that the UE 702 must either be notified or notified with privacy verification and if the UE 702 supports LCS notification (e.g., according to the UE capability information), a notification invoke message is sent to the target UE 702, indicating the identity of the LCS client 716 and the service type (if that is both supported and available) and whether privacy verification is required. Thus, in some aspects, Step 7 may involve the AMF 706 asking the UE 702 whether the LCS client 716 or the AF 720 is allowed to obtain location information of the UE 702.

At Step 8, the target UE 702 notifies the UE user of the location request and, if privacy verification was requested, waits for the user to grant or withhold permission. The UE 702 then returns a notification result to the AMF 706 indicating, if privacy verification was requested, whether permission is granted or denied for the current LCS request. If the UE user does not respond after a predetermined time period, the AMF 706 shall infer a no response condition. The AMF 706 shall return an error response in Step 14 (and if roaming, the VGMLC 710 forwards this response in Step 15 to the HGMLC 712) if privacy verification was requested and either the UE user denies permission or there is no response with the indication received from the (H)GMLC 712 indicating barring of the location request, Steps 10-13 are skipped. The notification result may also indicate the Location Privacy Indication setting for subsequent LCS requests, i.e., whether subsequent LCS requests, if generated, will be allowed or disallowed by the UE 702. The Location Privacy Indication may also indicate a time for disallowing the subsequent LCS requests.

At Step 9, the AMF 706 invokes the Nudm ParameterProvision Update (LCS privacy) service operation to store in the UDM 714 the Location Privacy Indication information received from the UE 702. The UDM 714 may then store the updated UE privacy setting information into the unified data repository (UDR) as the “LCS privacy” Data Subset of the Subscription Data.

At Step 10, the AMF 706 selects an LMF based on the available information or based on AMF local configuration. The LMF selection takes the 5G-AN currently serving the UE 702 into account. The selection may use an NRF query.

At Step 11, the AMF 706 invokes the Nlmf Location DetermineLocation service operation towards the LMF 708 to request the current location of the UE 702. The service operation includes a LCS Correlation identifier, the serving cell identity of the Primary Cell in the Master RAN node and the Primary Cell in the Secondary RAN node when available based on Dual Connectivity scenarios, and the client type and may include an indication if the UE 702 supports LTE Positioning Protocol (LPP), the required QoS, UE Positioning Capability if available and Supported GAD shapes. If any of the procedures in clause 6.11.1 or clause 6.11.2 of 3GPP TS 23.502 are used, the service operation includes the AMF identity.

At Step 12, the LMF 708 performs one or more positioning procedures. During this step, the LMF 708 may use the Namf Communication N1N2MessageTransfer service operation to request the transfer of a Positioning related N1 message to the UE 702 or the transfer of a Network Positioning message to the serving NG-RAN node 704 (e.g., gNB or NG-eNB) for the UE 702. The LMF 708 shall determine a geographical location and optionally a location in local coordinates.

At Step 13 of FIG. 7B, the LMF 708 returns the Nlmf_Location_DetermineLocation Response towards the AMF 706 to return the current location of the UE 702 and UE Positioning Capability if the UE Positioning Capability is received in step 8 including an indication that the capabilities are non-variable and not received from the AMF 706 in step 7. The service operation includes the LCS Correlation identifier, the location estimate, its age and accuracy and may include information about the positioning method and the timestamp of the location estimate.

At Step 14, the AMF 706 returns the Namf Location ProvidePositioninglnfo Response towards the GMLC/LRF to return the current location of the UE 702. The service operation includes the location estimate, its age and accuracy and may include information about the positioning method and the timestamp of the location estimate. The AMF 706 stores the UE Positioning Capability in UE context when received from the LMF 708.

At Step 15, in the case of roaming, the VGMLC 710 forwards the location estimation of the target UE 702, its age, its accuracy and optionally the information about the positioning method received at step 14 to the HGMLC 712. For the non-roaming scenario, this step is skipped.

If the privacy check in Step 2 indicates that further privacy checks are needed, at Step 16 the (H)GMLC 712 performs an additional privacy check in order to decide whether the (H)GMLC 712 can forward the location information to the LCS client 716 or the AF 720 or send a notification if the result of the privacy check requires the notification and verification based on current location. One example when this additional privacy check is needed is when the target UE user has defined different privacy settings for different geographical locations. When an additional privacy check is not needed, the (H)GMLC 712 skips Steps 17-23.

At Step 17, if the result of privacy checks in Step 16 indicates that the notification (and verification) based on current location is needed, and in the case of roaming, the (H)GMLC 712 shall send a location request to the VGMLC 710 with location type indicating “notification only”.

At Step 18, the (H)GMLC 712 or VGMLC 710 invokes the Namf_Location_ProvidePositioningInfo service operation towards the AMF 706 to request notification (and verification) based on current location.

At Step 19, if the UE 702 is in CM IDLE state, the AMF 706 initiates a network triggered Service Request procedure as defined in clause 4.2.3.3 of 3GPP TS 23.502 to establish a signaling connection with the UE 702.

At Step 20, if the indicator of privacy check related action indicates that the UE 702 must either be notified or notified with privacy verification and if the UE 702 supports LCS notification, the AMF 706 sends a notification invoke message to the target UE 702, indicating the identity of the LCS client 716 and the service type (if that is both supported and available) and whether privacy verification is required.

Step 21 is the same as Step 8.

At Step 22, the AMF 706 returns the Namf Location ProvidePositioninglnfo Response towards the (V)GMLC 710 (or HGMLC 712 for roaming when the NL3 reference point is not supported) with an indication of the result of the notification and verification procedure performed in Steps 20-21.

At Step 23, in the case of roaming, the VGMLC 710 forwards an indication of the result of notification and verification procedure to the HGMLC 712. For the non-roaming scenario, Step 23 is skipped.

At Step 24, the (H)GMLC 712 sends the location service response to the LCS Client 716 or the AF 720 (via the NEF 718) if the target UE 702 is allowed to be located by the LCS Client 716 or the AF 720. If the location request from the LCS Client 716 contained the pseudonym and the (H)GMLC 712 resolved the verinym from the pseudonym in step 1, the (H)GMLC 712 shall use the pseudonym of the target UE 702 in the location response to the LCS client 716 (e.g., an external LCS client). If the external LCS client 716 or the AF 720 requires it, the (H)GMLC 712 may first transform the universal location co-ordinates provided by the AMF 706 into some local geographic reference system. The (H)GMLC 712 may record charging information both for the LCS Client 716 or the AF 720 and inter-network revenue charges from the AMF's network. The location service response from the (H)GMLC 712 to the LCS Client 716 or the AF 720 may contain the information about the positioning method used and the indication whether the obtained location estimate satisfies the requested accuracy or not. If in Step 2, Step 15, Step 16, or Step 23 the (H)GMLC 712 identifies that the target UE is not allowed to be located by the LCS Client 716 or the AF 720, it rejects the LCS service request, and optionally indicates in the response the reason of the rejection, i.e., the target UE is not allowed to be located. If the LCS QoS Class is Assured and the (H)GMLC 712 detects that requested accuracy is not achieved, the (H)GMLC 712 sends an error response including failure cause.

Some wireless communication networks may use so-called assisting nodes to provide a desired level of wireless communication capacity (e.g., connectivity, bandwidth, and throughput) and reliable coverage. In some examples, an assisting node may take the form of a remote unit, a repeater, a reflector, a lower-layer relay (e.g., wireless RUs or TRPs) that has limited (or no) scheduling capability or MAC functionality, a higher-layer relay (e.g., that includes higher layer functionality), and so on.

Assisting nodes such as relays may be incorporated into movable objects (e.g., vehicles such as cars, vans, trucks, busses, boats, trains, drones, etc.). In some examples, a mobile assisting node such as vehicle mounted relay (VMR) may take the form of a mobile base station relay. For example, a VMR may be based on the IAB architecture discussed above, whereby the VMR may include gNB DU and UE functionality. In some examples, a VMR may obtain coverage from a stationary macro network (e.g., donor gNBs). The VMR may then provide coverage/connectivity to nearby UEs (e.g., in the same vehicle as the VMR and/or in the vicinity of the vehicle).

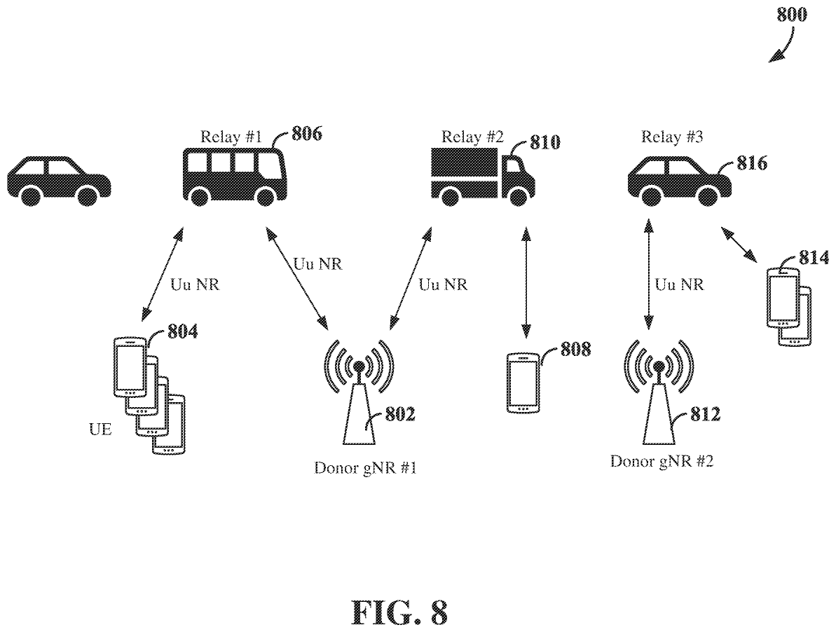

FIG. 8 illustrates an example of a wireless communication system 800 that includes mobile assisting nodes. A first donor gNB 802 serves one or more UEs 804 via a first mobile relay 806 (e.g., a VMR) and serves another UE 808 via a second mobile relay 810 (e.g., a VMR). In addition, a second donor gNB 812 serves one or more UEs 814 via a third mobile relay 816 (e.g., a VMR).

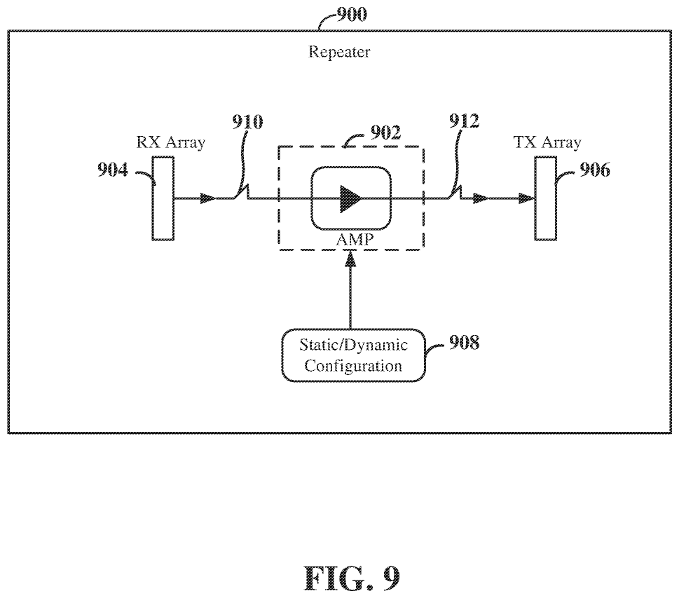

FIG. 9 illustrates one example of a low-functionality assisting node, specifically, a repeater 900. The repeater 900 may include an amplifier 902, one or more antenna arrays (or antennas, antenna panels, and/or the like) such as a first array 904 and second array 906, and a configuration unit 908.

An antenna array may include multiple antenna elements capable of being configured for beamforming. An antenna array may be referred to as a phased array because phase values and/or phase offsets of the antenna elements may be configured to form a beam, with different phase values and/or phase offsets being used for different beams (e.g., in different directions). In some aspects, an antenna array may be a fixed receive (Rx) antenna array capable of only receiving communications while not transmitting communications. In some aspects, an antenna array may be a fixed transmit (Tx) antenna array capable of only transmitting communications while not receiving communications. In some aspects, an antenna array may be configured to act as an Rx antenna array or a Tx antenna array (e.g., via a Tx/Rx switch, a MUX/DEMUX, and/or the like). An antenna array may be capable of communicating using millimeter waves and/or other types of RF analog signals.

The amplifier 902 includes one or more components capable of amplifying an input signal and outputting an amplified signal. For example, the amplifier 902 may include a power amplifier, a variable gain component, and/or the like. In some examples, the amplifier 902 may have variable gain control. In some examples, the level of amplification of the amplifier 902 may be controlled by the configuration unit 908 (e.g., under the direction of the network).

Switches 910 and 912 include one or more components capable of enabling the repeater 900 to use different antenna arrays for receiving or transmitting. For example, the repeater 900 may include other circuitry and connections (not shown) that would enable reception via the second array 906 and transmission via the first array 904.

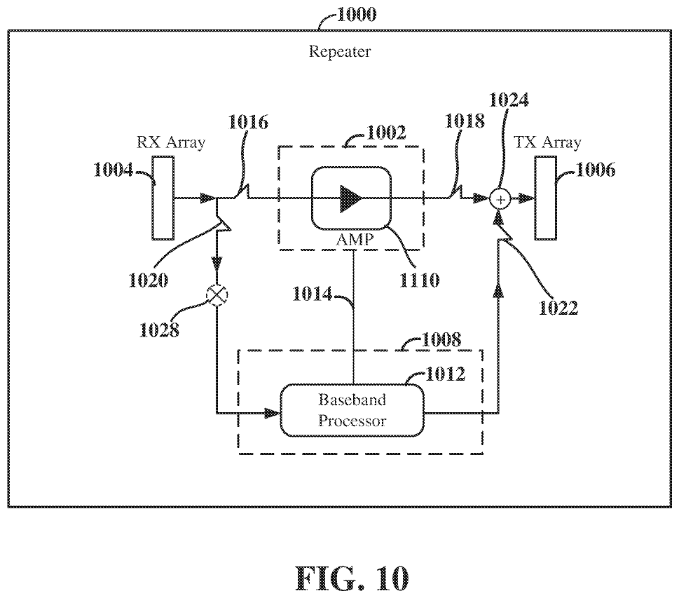

As mentioned above, in some examples, a repeater may provide higher layer repeating functionality. FIG. 10 illustrates an example of a repeater 1000 that may provide decode and forward functionality.

The repeater 1000 may include an amplifier unit 1002, one or more antenna arrays (or antennas, antenna panels, and/or the like) such as a first array 1004 and a second array 1006, and a control unit 1008 as discussed herein. The amplifier unit 1002 includes an amplifier 1010 for amplifying signals received via the first array 1004 and transmitting the amplified signals via the second array 1006. The control unit 1008 includes a baseband processor 1012 for processing signals received from another node (not shown) over a control path, controlling the operation of the amplifier unit 1002 as necessary (e.g., via control signaling 1014), and transmitting signals to the other node via the control path.

The amplifier 1010 includes one or more components capable of amplifying an input signal and outputting an amplified signal. For example, the amplifier 1010 may include a power amplifier, a variable gain component, and/or the like. In some aspects, amplifier 1010 may have variable gain control. In some examples, the level of amplification of the amplifier 1010 may be controlled by the baseband processor 1012 (e.g., under the direction of a base station).

The baseband processor 1012 includes one or more components capable of controlling one or more other components of the repeater 1000. For example, the baseband processor 1012 may include a controller, a microcontroller, a processor, and/or the like. In some aspects, the baseband processor 1012 may control a level of amplification or gain applied by the amplifier 1010 to an input signal. Additionally, or alternatively, the baseband processor 1012 may control an antenna array by controlling a beamforming configuration for the antenna array (e.g., one or more phase values for the antenna array, one or more phase offsets for the antenna array, one or more power parameters for the antenna array, one or more beamforming parameters for the antenna array, a Tx beamforming configuration, an Rx beamforming configuration, and/or the like), by controlling whether the antenna array acts as a receive antenna array or a transmit antenna array (e.g., by configuring interaction and/or connections between the antenna array and switches), and/or the like. Additionally, or alternatively, the baseband processor 1012 may power on or power off one or more components of the repeater 1000 (e.g., when a base station does not need to use the repeater to serve UEs). In some aspects, the baseband processor 1012 may control timing of one or more of the above configurations.

The baseband processor 1012 may include a component capable of communicating with another node (e.g., a base station) via the control path. In some aspects, the baseband processor 1012 may communicate with the other node using one or more in-band radio frequencies (e.g., radio frequencies that are included within an operating frequency bandwidth of the antenna arrays). In this case, the other node may configure a BWP within the operating frequency bandwidth of the antenna arrays (e.g., an in-band BWP) such that the BWP carries the control interface associated with the repeater 1000.

In some examples, the baseband processor 1012 may include one or more components for digital signal processing (e.g., digital signal processor, a baseband processor, a digital-to-analog converter (DAC), an analog-to-digital converter (ADC), and/or the like). In this way, the baseband processor 1012 may demodulate, decode, and/or perform other types of processing on the control information and/or data received from a base station.

Switches 1016, 1018, 1020, and 1022 include one or more components capable of enabling the repeater 1000 to either relay a signal received via a receive antenna array or to transmit an RF analog signal generated by the repeater 1000 (e.g., generated by the amplifier unit 1002). For example, in one configuration, the switches 1016, 1018, 1020, and 1022 may be configured to couple the amplifier unit 1002 to the first array 1004 and the second array 1006. In another configuration, the switches 1016, 1018, 1020, and 1022 may be configured to couple the control unit 1008 to the first array 1004 and the second array 1006. In some examples, the position of each of the switches 1016, 1018, 1020, and 1022 may be controlled by the control unit 1008.

Switches (not shown) may be used to multiplex and/or demultiplex communications received from and/or transmitted to an antenna array. For example, switches (e.g., multiplexer/demultiplexers) may be used to switch an Rx antenna array to a Tx antenna array, or vice versa.

A summer 1024 (e.g., a multiplexer) may include functionality to combine signals from the amplifier 1010 with signals from the control unit 1008. For example, signals for the data path may be provided on the frequency bands for the BWPs allocated for data transmission, while signals for the control path may be provided on the frequency band(s) for the BWP allocated for control transmission. A demultiplexer 1028 could be used in some examples (e.g., to demultiplex the control path from an incoming signal).

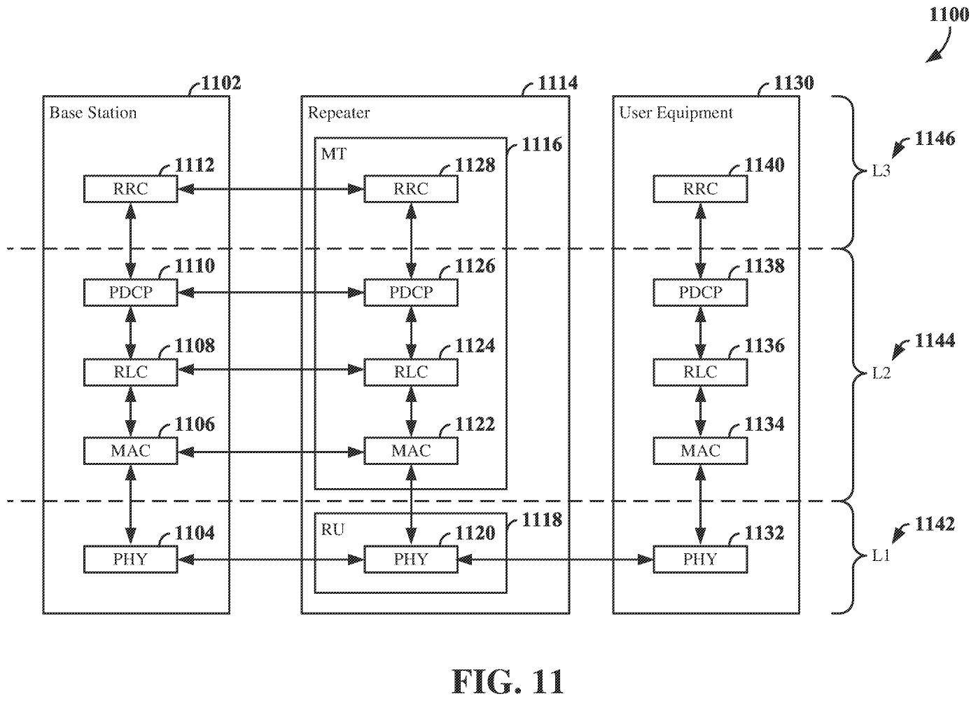

FIG. 11 is a diagram illustrating an example of a radio protocol architecture 1100 for a control plane that may be used with a higher-functionality repeater (e.g., the repeater 1000 of FIG. 10) according to some aspects of the disclosure. In particular, FIG. 11 depicts a control plane protocol stack for a base station 1102, a repeater device 1114, and a UE 1130. The radio protocol architecture 1100 may be for a 5G wireless system in some examples. The base station 1102 may correspond to any of the base stations (e.g., gNBs,) or scheduling entities shown in any of FIGS. 1, 2, 4, 5, 6, 7A, 7B, 8, 12, and 15. The UE 1130 may be any of the UEs or scheduled entities shown in any of FIGS. 1, 2, 4, 5, 6, 7A, 7B, 8, 12, 13, 14, and 17. The repeater device 1114 may be any of the assisting nodes (e.g., repeaters) shown in any of FIGS. 1, 2, 4-10, 13, and 14.

As illustrated in FIG. 11, the radio protocol architecture 1100 includes three layers: layer 1 (L1), layer 2 (L2), and layer 3 (L3). L1 1142 is the lowest layer, L2 1144 is above L1 1142, and L3 1146 is above L2 1144.

With respect to the repeater device 1114, an implementation of the protocol stack may be divided between a relay unit (RU) 1118 in L1 1142 and a mobile termination (MT) 1116 in L2 1144 and L3 1146. In L1 1142, the physical layer 1120 of the RU 1118 may operate as a relay, relaying modulated RF analog signals (e.g., digital content on analog carriers) in the uplink and downlink directions between the physical layer 1104 of the base station 1102 and the physical layer 1132 of the UE 1130. There are at least two types of relay procedures that may be used by the repeater device 1114 to relay traffic (e.g., user data signals and control signals) through the repeater device 1114 between the base station 1102 and the UE 1130. A first relay procedure may be referred to as a Layer-1 relay procedure, which may be implemented by a Layer-1 relay. A second relay procedure may be referred to as a Layer-2 relay procedure.

In some examples, the repeater device 1114 may be configured as a Layer-1 relay operating according to a Layer-1 relay procedure. When operating as a Layer-1 relay, the repeater device 1114 receives a signal as a modulated RF waveform at a receiver coupled to a receive antenna array, amplifies the signal, and retransmits the signal from a transmitter coupled to a transmit antenna array. Therefore, a Layer-1 relay may be referred to as an amplify and forward relay. In general, a Layer-1 relay may not require a great amount of upper level functionality to perform the amplify and forward type function and may be less complex and less costly than a Layer-2 relay.

In some examples, the repeater device 1114 may be configured to operate as a Layer-2 relay. When operating as an Layer-2 relay, the repeater device 1114 may receive a signal as a modulated RF waveform at receiver coupled to a receive antenna array, demodulate and decode the signal to obtain a digital representation of the signal, re-encode and re-modulate the signal, amplify, and then forward the signal from a transmitter coupled to a transmit antenna array. Therefore, a Layer-2 relay may be referred to as a decode and forward type of relay. In general, a Layer-2 relay is more complex than a Layer-1 relay and may require a greater amount of upper level functionality (in comparison to a Layer-1 relay) to perform the decode and forward type of operation. Therefore, the Layer-2 relay may be more complex and more costly than a Layer-1 relay. According to some aspects of the disclosure, the repeater device 1114 may be configured as, and referred to as, a smart repeater device. The smart repeater device may apply some upper level functionality to a Layer-1 relay but may not provide the level of functionality that would be required to operate as a Layer-2 relay. For example, while the smart repeater device may not use higher level functionality to demodulate, decode, encode, and re-modulate a signal, the smart relay may use higher level functionality to sense channels, implement MIMO functionality, select various beams in conjunction with a use of various synchronization signal block (SSB) information and transmission configuration indicator (TCI) states, and may adjust transmit power of a modulated RF waveform being amplified and forwarded by the Layer-1 relay of the smart repeater device.

The various protocol layers illustrated in FIG. 11 for each of the base station 1102, the repeater device 1114, and the UE 1130 are similar and will be described once to avoid repetition. The layers include the PHY layer 1104, 1120, 1132 at the L1 layer 1142, the medium access control (MAC) layer 1106, 1122, 1134, the radio link control (RLC) layer 1108, 1124, 1136, the packet data convergence protocol (PDCP) layer 1110, 1126, 1138 at the L2 layer 1144, and the RRC layer 1112, 1128, 1140 at the L3 layer 1146.

The physical (PHY) layer 1104, 1120, 1132 may be responsible for transmitting and receiving data on physical channels (e.g., within slots). MAC service data units (SDUs) may be placed in MAC protocol data units (PDUs) for transport over transport channels to the PHY layer 1104, 1120, 1132. A PHY context may indicate a transmission format and a radio resource configuration (e.g., BWP, numerology, etc.). Functions of the PHY layer 1104, 1120, 1132 may include, for example, error detection on transport channels and indications to higher layers, forward error correction encoding/decoding of the transport channels, hybrid automatic repeat request (HARQ) soft-combining, rate matching of the coded transport channel to physical channels, mapping of the coded transport channel onto physical channels, power weighting of physical channels, modulation and demodulation of physical channels, frequency and time synchronization, radio characteristics measurements and indication to higher layers, multiple input multiple output (MIMO) antenna processing, transmit diversity, digital and analog beamforming, and RF processing.

The MAC layer 1106, 1122, 1134 may provide services to upper layers and obtains services from the PHY layer 1104, 1120, 1132. The PHY layer 1104, 1120, 1132 offers transport channels to the MAC layer 1106, 1122, 1134 to support transport services for data transfer over the radio interface. The MAC layer 1106, 1122, 1134 offers logical channels to the RLC layer 1108, 1124, 1136. The logical channels exist between the MAC and PHY layers, while transport channels exist between the PHY and radio layers. Therefore, the MAC layer may be an interface between higher layer logical channels and PHY layer transport channels. The functions of the MAC layer 1106, 1122, 1134 may include, for example, beam management random access procedure, mapping between logical and transport channels, and concatenation of multiple MAC SDUs belonging to one logical channel into a transport block (TB).

The RLC layer 1108, 1124, 1136 may provide segmentation and reassembly of upper layer data packets, error correction through automatic repeat request (ARQ), and sequence numbering independent of the PDCP sequence numbering. An RLC context may indicate whether an acknowledged mode (e.g., a reordering timer is used) or an unacknowledged mode is used for the RLC layer 1108, 1124, 1136.

The PDCP layer 1110, 1126, 1138 may provide packet sequence numbering, in-order delivery of packets, retransmission of PDCP protocol data units (PDU), and transfer of upper layer data packets to lower layers. PDUs may include, for example, Internet Protocol (IP) packets, Ethernet frames and other unstructured data (e.g., machine-type communication (MTC), hereinafter collectively referred to as “packets”). The PDCP layer 1110, 1126, 1138 may also provide header compression for upper layer data packets to reduce radio transmission overhead, security by ciphering the data packets, and integrity protection of data packets. A PDCP context may indicate whether PDCP duplication is utilized for a unicast connection, for example.

The RRC layer 1112, 1128, 1140 of the L3 layer 1146 may be responsible for establishing and configuring signaling radio bearers (SRBs) and data radio bearers (DRBs) between the base station 1102 and the UE 1130 and/or between the base station 1102 and the repeater device 1114, paging initiated by the 5GC or NG-RAN, and broadcast of system information related to Access Stratum (AS) and Non Access Stratum (NAS). The RRC layer 1112, 1128, 1140 may further be responsible for QoS management, mobility management (e.g., handover, cell selection, inter-RAT mobility), UE 1130 measurement and reporting, and security functions. In the user plane (not shown), the radio protocol architecture for the base station 1102, the repeater device 1114, and the UE 1130 are substantially similar for the L1 layer 1142 and the L2 layer 1144 and will not be repeated to avoid repetition. The user plane protocol stack does not include an RRC layer 1112, 1128, 1140. The user plane protocol stack does include, for example, a service data adaptation protocol (SDAP) layer (not shown) in the L3 layer 1146. The SDAP layer (not shown) may provide a mapping between a 5G core (5GC) quality of service (QoS) flow and a data radio bearer and performs QoS flow ID marking in both downlink and uplink packets.

As discussed above in conjunction with FIGS. 6-7B, a location services client may send a request to a network for the location of a user equipment. In some examples, a privacy attribute associated with the user equipment may dictate whether a particular location services client (e.g., associated with services other than regulatory services) is allowed to obtain the location of the user equipment. In this case, the network may perform a privacy check procedure to determine whether the network is allowed to send the location of the user equipment to a requesting location services client.

In some examples, a mobile relay may forward location services information received from a network entity to a user equipment and/or forward location services information received from a user equipment to a network entity. In some examples, the mobile relay may have one or more attributes of (e.g., some of the functionality of) a user equipment in the network.

In some examples, there may be a need to determine the location of a mobile relay. For example, this information may be provided to a CN for assisting the positioning of a UE served by the mobile relay. As another example, there may be a need to check the location of the mobile relay. Thus, a location services client could request the location of the mobile relay.

As discussed above in conjunction with FIGS. 6-7B, except for regulatory location services (e.g., emergency calls), location services will perform privacy check/verification procedures when servicing a location request. However, a mobile relay might not support a privacy check (e.g., the mobile relay simply provides a relay function). Consequently, the use of an unnecessary privacy check procedure directed to the mobile relay may lead to an error case (e.g., no response to a location request) and/or waste valuable resources and/or result in redundant signaling and latency since it is not necessary to verify privacy for a mobile relay. Thus, privacy verification in the mobile relay context may adversely affect latency performance and communication performance in general.

The disclosure relates in some aspects to optimizing the privacy check/verification procedures for the mobile relay context. For example, the network may be prevented from performing a privacy check procedure for a mobile relay. As discussed in more detail below, in a first example (Example 1), a mobile relay may determine whether to indicate its LCS notification capability to the CN based on provisioning information. For example, a mobile relay may utilize subscription data indicating that the mobile relay (e.g., UE) is a specific type of terminal to determine whether to indicate its LCS notification capability to the CN. In a second example (Example 2), an AMF may determine whether to keep/discard the LCS related capability of a mobile relay based on the subscription data. In a third example (Example 3-1 or 3-2), a data set may be used to determine whether a privacy check is needed. In Example 3-1, a new privacy profile data type is defined (Target UE Type Indication). For example, if a user is not involved in privacy check for a particular UE type, then all LCS clients are considered as external LCS clients where location reporting is allowed without notification (e.g., without a privacy check). In Example 3-2, subscription data (e.g., as defined in Example 1) may be used to determine whether the privacy check is needed.

Examples 1, 2, 3-1, and 3-2 may be applied to any procedures involving a privacy check during an MT-LR procedure (e.g., as described in FIG. 7A and 7B). In addition, in each procedure, different entities may perform the corresponding operations of any of Examples 1, 2, 3-1, and 3-2. For instance, an LCS client (e.g., which is the entity that requests the location of a UE) can be any of the entities shown in FIG. 7A and 7B. As one example, the location requestor of a Mobile Base Station Relay (MBSR) may be an LMF in some cases.

In the first example (Example 1), a mobile relay determines which LCS related capability information it will report. For example, the mobile relay may determine whether to indicate its LCS notification capability to a CN based on provisioning information.

In some LCS systems, an LCS notification is used for UE privacy check/verification during a 5GC-mobile terminated-location request (5GC-MT-LR) procedure. For example, to enable LCS service, a UE may indicate its LCS capabilities to the CN when the UE registers with the CN. In some examples, a UE sets an LPP bit to “LPP in N1 mode supported” and an 5G-LCS bit to “LCS notification mechanisms supported” in the 5GMM capability IE of a Registration Request message.

In Example 1, this provisioning information may be set to indicate that the mobile relay only supports LPP capability although it has all the capabilities for supporting LCS. That is, the mobile relay only indicates “LPP in N1 mode supported” in the Registration Request when it registers to CN.

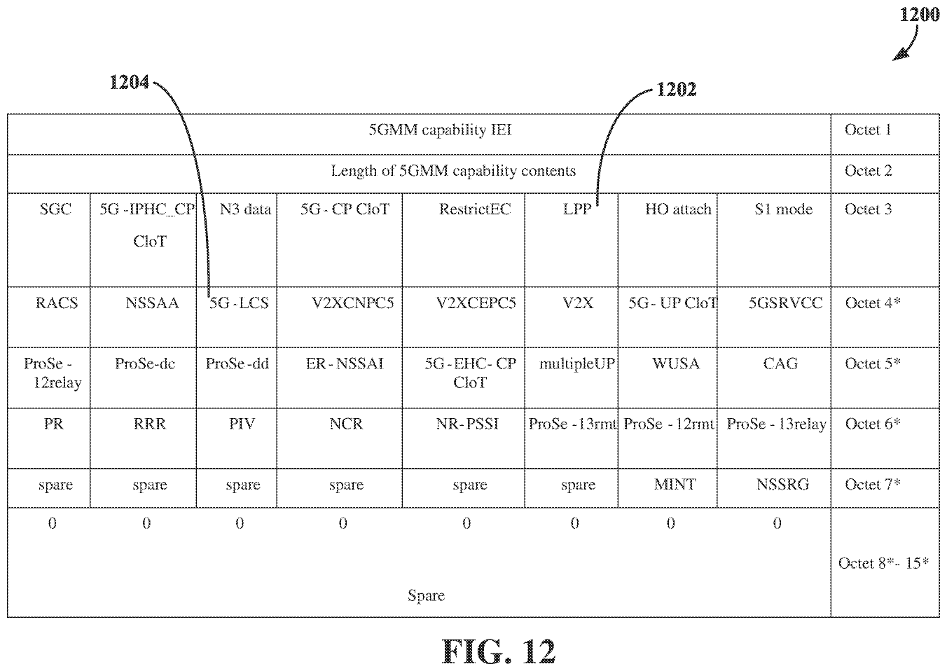

FIG. 12 is a conceptual diagram of an example of a 5G mobility management (5GMM) capability information element (IE) 1200 as defined in Table 9.11.3.1.1 of 3GPP TS 24.501 v17.6.1.

The 5GMM capability IE 1200 includes an LTE Positioning Protocol (LPP) capability field 1202. In some examples, a value of zero (0) in the LPP capability field 1202 indicates that LPP is not supported. In some examples, a value of one (1) in the LPP capability field 1202 indicates that LPP is supported.

The 5GMM capability IE 1200 also includes a location services (5G-LCS) notification mechanisms capability field 1204. In some examples, a value of zero (0) in the 5G-LCS notification mechanisms capability field 1204 indicates that LCS notification mechanisms are not supported. In some examples, a value of one (1) in the 5G-LCS notification mechanisms capability field 1204 indicates that LCS notification mechanisms are supported.

Thus, in Example 1, a mobile relay may send capability information to the network indicating that the first wireless communication device supports a location services protocol but does not support location services notifications. Upon receiving this capability information, the network may refrain from performing a privacy check procedure directed to the mobile relay.

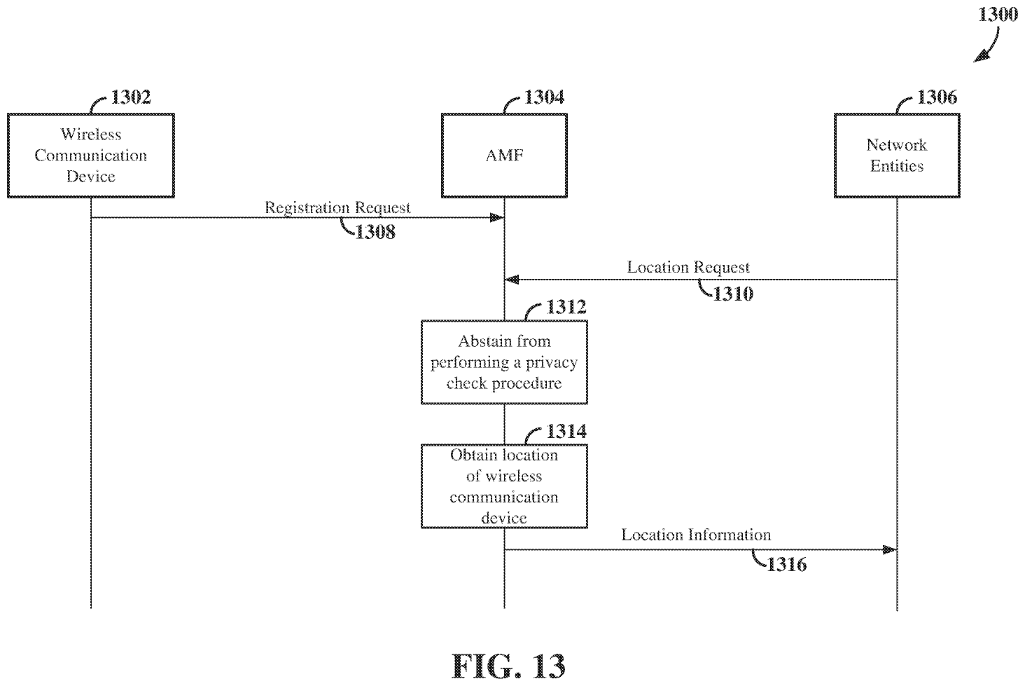

FIG. 13 is a signaling diagram 1300 illustrating an example of signaling associated with Example 1 in a wireless communication system including a first wireless communication device 1302, an AMF 1304, and network entities 1306 (e.g., including a GMLC). In some examples, the first wireless communication device 1302 may correspond to any of the wireless communication devices shown in any of FIGS. 1, 2, 4-11, 14, 16, and 17. In some examples, the AMF 1304 and the network entities 1306 may correspond to one or more of the network entities shown in any of FIGS. 1, 2, 4-8, 14, 16, 19, and 22.

At #1308 of FIG. 13, the first wireless communication device 1302 sends a registration request to the AMF 1304 (e.g., via a gNB). As discussed herein, the registration request may include a 5GMM capability IE. Also as discussed herein, the first wireless communication device 1302 may have set an LPP field of the 5GMM capability IE to indicate that LPP is supported by the first wireless communication device 1302. In addition, the first wireless communication device 1302 may have set a 5G-LCS field of the 5GMM capability IE to indicate that LCS notification mechanisms are not supported by the first wireless communication device 1302.

At #1310, the AMF 1304 receives a location request directed to the first wireless communication device 1302 from the network entities 1306 (e.g., a location request originating from an LCS client). As a result of the 5GMM capability IE for the first wireless communication device 1302 indicating that LCS notification mechanisms are not supported, at #1312, the AMF 1304 may abstain from performing a privacy check procedure for the first wireless communication device 1302 in response to the location request.

At #1314, the AMF 1304 obtains the location of the first wireless communication device 1302 (e.g., in cooperation with an LMF as discussed in FIGS. 7A and 7B). As discussed above, this location procedure is done without performing a privacy check with respect to the first wireless communication device 1302.

At #1316, the AMF 1304 sends the location information determined at #1314 to the network entities 1306. Thus, the location information may be provided to the requesting LCS client.

In the second example (Example 2), an AMF determines whether to keep the LCS related capability information provided by a mobile relay. For example, the AMF may determine whether to keep/discard the LCS related capability of UE based on subscription data of the mobile relay.

In some LCS systems, LCS notification is used for a UE privacy check/verification during an 5GC-MT-LR Procedure. For example, a mobile relay may be a form of UE that sends its capabilities to the CN during registration (e.g., via UE capabilities information).

In Example 2, the AMF determines whether or not to keep the LCS related capability information provided by the mobile relay depending on the subscription data of the mobile relay. For example, the subscription data may include capability information indicating that the UE is a particular type of device (e.g., a particular type of UE, a mobile relay, a VMR, a UE which does not require user interaction, etc.). As an example, the above mentioned subscription data can be included in the data type: AccessAndMobilitySubscriptionData in UDM as shown in Table 1.

TABLE 1

| Attribute | Data | | Cardi- | |
|---|---|---|---|---|
| name | type | P | nality | Description |
| VMROpera- | Boolean | O | 0 . . . 1 | Indicates whether the UE is |
| tionAllowed | | | | allowed for VMR operation. |
| | | | | true: indicates that the UE is |
| | | | | allowed for VMR operation |
| | | | | false: indicates that the UE is |
| | | | | not allowed for VMR operation |

If the subscription data indicates that the mobile relay is of a particular type, and the positioning capability information provided to the AMF/CN includes “LPP in N1 mode supported” and “LCS notification mechanisms supported,” the AMF may discard “LCS notification mechanisms supported” as the LCS positioning capability, only keeping “LPP in N1 mode supported” as the LCS positioning capability.

Thus, in Example 2, the network may refrain from performing a privacy check procedure directed to a mobile relay based on a determination that the mobile relay is a particular type of device (e.g., one that performs a relay function or otherwise does not support privacy checks or user interaction).

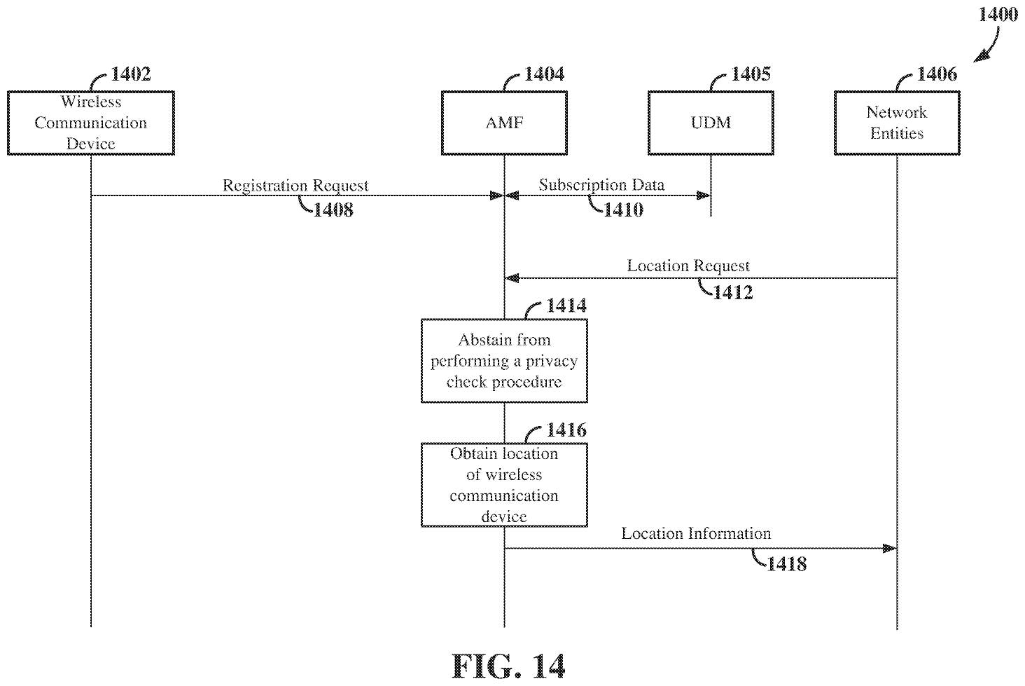

FIG. 14 is a signaling diagram 1400 illustrating an example of signaling associated with Example 2 in a wireless communication system including a first wireless communication device 1402, an AMF 1404, a UDM 1405, and network entities 1406. In some examples, the first wireless communication device 1402 may correspond to any of the wireless communication devices shown in any of FIGS. 1, 2, 4-11, 13, 16, and 17. In some examples, the AMF 1404, the UDM 1405, and the network entities 1406 may correspond to one or more of the network entities shown in any of FIGS. 1, 2, 4-8, 13, 16, 19, and 22.

At #1408 of FIG. 14, the first wireless communication device 1402 sends a registration request to the AMF 1404 (e.g., via a gNB). As discussed herein, the registration request may include a 5GMM capability IE. Also as discussed herein, the first wireless communication device 1402 may have set an LPP field of the 5GMM capability IE to indicate that LPP is supported by the first wireless communication device 1402. In addition, the first wireless communication device 1402 may have set a 5G-LCS field of the 5GMM capability IE to indicate that LCS notification mechanisms are supported by the first wireless communication device 1402.

At #1410, the AMF 1404 sends subscription data of the first wireless communication device 1402 to the UDM 1405. This subscription information may indicate that the first wireless communication device 1402 is a device of a particular type (e.g., a particular type of UE, a mobile relay, a VMR, etc.).

At #1412, the AMF 1404 receives a location request directed to the first wireless communication device 1402 from the network entities 1406 (e.g., a location request originating from an LCS client). As a result of the subscription data received at #1410 indicating that the first wireless communication device 1402 is a device of a particular type, at #1414, the AMF 1404 may abstain from performing a privacy check procedure for the first wireless communication device 1402 in response to the location request.

At #1416, the AMF 1404 obtains the location of the first wireless communication device 1402 (e.g., in cooperation with an LMF as discussed in FIGS. 7A and 7B). As discussed above, this location determination is done without performing a privacy check.

At #1418, the AMF 1404 sends the location information determined at #1416 to the network entities 1406. Thus, the location information may be provided to the requesting LCS client.

In the third example (Example 3-1 and 3-2), a GMLC determines whether to proceed with the privacy check of a mobile relay. In Example 3-1, a new privacy profile data type, ‘Target UE type indication’ may be used. In Example 3-2, subscription data (e.g., as described herein) may be used.

In Example 3-1, in some LCS systems, privacy preferences for a UE are stored in a UE LCS privacy profile as part of UE subscription data in the UDM.

In Example 3-1, the privacy profile data type ‘Target UE type indication’ indicates whether the location service procedure for privacy check needs to be performed for a UE of a specific type. For example, for a mobile relay, ‘User is not involved for privacy check’ may be applied in the privacy profile data type. In this case, all LCS clients will be considered as external LCS clients where location requests are allowed without notification to the mobile relay (e.g., without a privacy check). Conversely, for UEs that need to enforce user privacy, ‘User is involved for privacy check’ may be applied in the privacy profile data type. In this case, a privacy check will be performed for location requests to the UE (except for regulatory location requests).

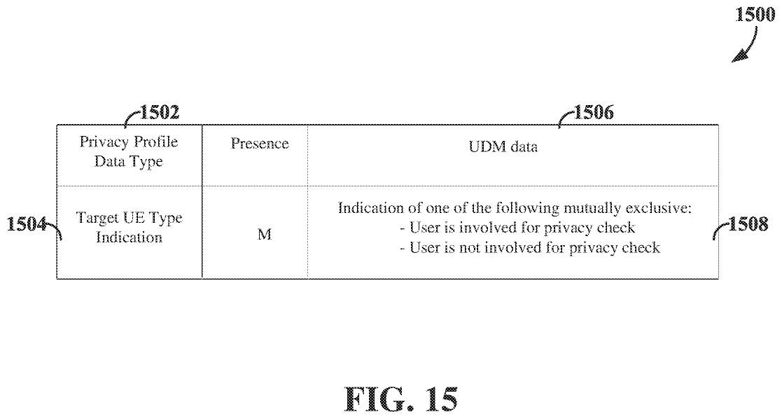

FIG. 15 is a conceptual diagram of an example of a privacy profile 1500. Here, a privacy profile data type 1502 is defined as a target UE type indication 1504. Thus, the privacy profile 1500 corresponds to a particular type of UE (e.g., a mobile relay, etc.). The UDM data 1506 contained in the privacy profile 1500 indicates one of two mutually exclusive conditions 1508. A first condition (e.g., corresponding to a UDM data value of zero (0)) specifies that a user is involved for privacy check. For example, this first condition may be set for a UE that is used by a user. A second condition (e.g., corresponding to a UDM data value of one (1)) specifies that a user is not involved for privacy check. For example, this second condition may be set for a mobile relay or other similar device.

Thus, in Example 3-1, the network may determine, based on a privacy profile of a mobile relay, that the mobile relay is a type of device that does not support privacy checks (e.g., a user of the mobile relay is not involved for privacy checks).

In Example 3-2, the subscription data specifies whether the location service procedure for a privacy check needs to be performed for a UE of a specific type. Here, if the subscription data indicates that a UE is particular type of device (e.g., a particular type of UE, a mobile relay, a VMR, a UE which does not require user interaction, etc.), the network considers that it is not necessary to examine the privacy profile data type (e.g., a user of the mobile relay is not involved for privacy checks). Thus, in Example 3-2, the network may determine to skip the location procedure for a privacy check.

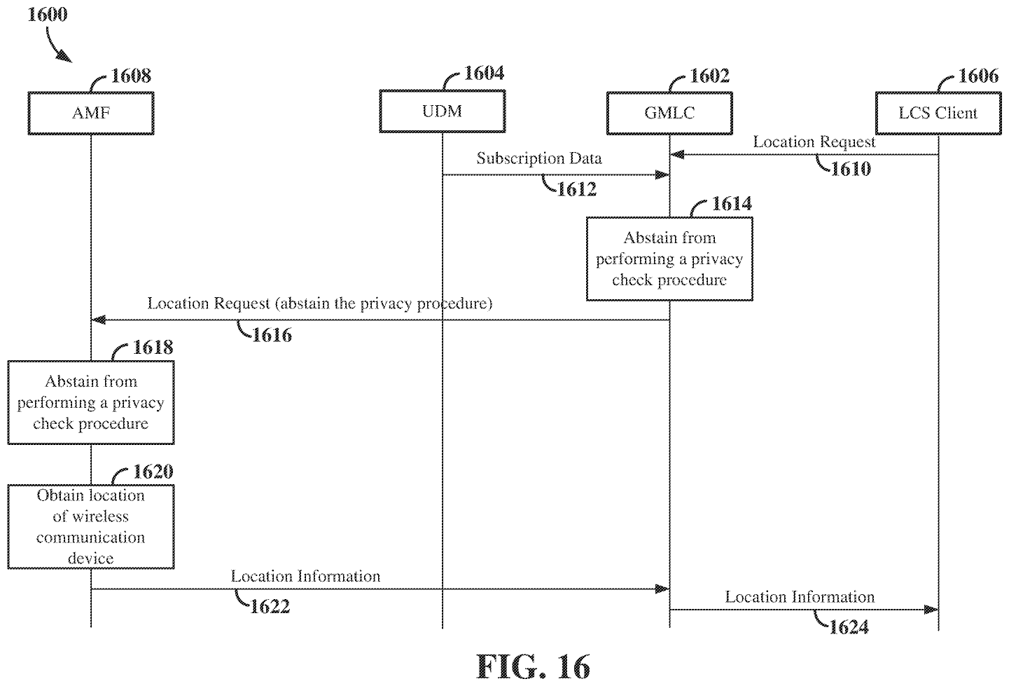

FIG. 16 is a signaling diagram 1600 illustrating an example of signaling associated with Example 3 in a wireless communication system including a GMLC 1602, a UDM 1604, an LCS client 1606, and an AMF 1608. In some examples, the GMLC 1602, the UDM 1604, the LCS client 1606, and the AMF 1608 may correspond to one or more of the network entities shown in any of FIGS. 1, 2, 4-8, 13, 14, 19, and 22.

At #1610 of FIG. 16, the GMLC 1602 receives a location request directed to a wireless communication device from the LCS client 1606.

At #1612, the GMLC 1602 receives subscription data for the wireless communication device from the UDM 1604. As discussed above, the subscription data may indicate a privacy profile for the wireless communication device or the capability information indicating that the wireless communication device is a particular type of device (e.g., mobile relay). In some examples, the subscription data may be initially stored in the UDM 1604 in conjunction with registration of the wireless communication device with the CN (e.g., as illustrated in FIG. 14). In some examples, the GMLC 1602 receives the subscription data from the UDM 1604 at Step 2 of FIG. 7A.

At #1614, as a result of the subscription data received at #1612 indicating that the wireless communication device has a particular privacy profile (e.g., “user is not involved for privacy check”) or capability information indicating that the wireless communication device is a particular type of device (e.g., mobile relay), the GMLC 1602 may abstain from performing a privacy check procedure for the wireless communication device in response to the location request.

At #1616, the GMLC 1602 sends a location request that requests the location of the wireless communication device to the AMF 1608. In some examples, this location request may include an indication that an LCS privacy check is not required for the wireless communication device.

At #1618, as a result of the location request received at #1616 indicating that an LCS privacy check is not required, the AMF 1608 may abstain from performing a privacy check procedure for the wireless communication device in response to the location request.

At #1620, the AMF 1608 obtains the location of the wireless communication device (e.g., in cooperation with an LMF as discussed in FIGS. 7A and 7B). As discussed above, this is done without performing a privacy check.

At #1622, the AMF 1608 sends the location information obtained at #1620 to the GMLC 1602. At #1624, the GMLC 1602 forwards the location information to the LCS client 1606.

As mentioned above, the operations of Examples 1, 2, 3-1, and 3-2 may be performed by different entities in different examples. For example, the LCS client 1606 may be an LMF in some cases or some other entity in other cases.

In view of the above, the disclosure relates in some aspects to a new solution relating to Vehicle Mounted Relays for location services support for UEs accessing a network via an MBSR. For example, this solution may support location services for the UEs served by a mobile base station relay that moves (with or without changing IAB-donor gNBs); or roams to VPLMN).

Proposed solutions (#6, #7, and #8) in the 3GPP TR 23.700-05 v0.2.0 for supporting location services of the UE served by an MBSR assume the positioning of the MBSR in addition to the positioning of the target UE.

For location services excepting for the regulatory location service, 5GC-MT-LR procedure involves UE LCS privacy check. UE LCS privacy is a feature which allows a UE and/or AF to control which LCS clients and AFs are and are not allowed access to UE location information. UE LCS privacy can be supported via subscription and via UE LCS privacy profile handling.

According to the existing 5GC-MT-LR Procedure (FIG. 6.1.2-1) in 3GPP TS 23.273, Steps 2, 7, 8, 9, 16, 17, 18, 19, 20, 21, 22, and 23 are related to the UE LCS privacy check. Based on the subscription data obtained in Step 2, the GMLC and AMF interact with the UE/User for UE/User LCS notification, which involves LCS related UE 5GMM capability.

As described, the UE LCS privacy check involves the interaction with the UE/User, because the commercial location services which triggers this 5GC-MT-LR Procedure mainly target the end user. On the other hand, an MBSR itself is a serving gNB/network entity. In case the positioning of the MBSR is additionally performed for the UE served by an MBSR (e.g., as described in the solution #6, #7, and #8), the UE LCS privacy check procedures for MBSR is not needed and may increase latency.

In order to solve the issue, there are several possible options:
1) MBRS-centric option:
   In this option, based on provisioning information, the MBSR is set not to indicate its LCS notification capability to the AMF/CN during, e.g., a registration procedure.
   The AMF/CN does not invoke the UE LCS privacy check during the 5GC-MT-LR Procedure accordingly. For this procedure, the AMF may check the subscription data not to reject the location request.
2) AMF/CN and subscription data-centric option:
   In this option, the AMF/CN determines whether to keep or discard the LCS notification capability transferred from the UE based on the subscription data.
   The subscription data includes the information that the UE is an MBSR.
   The MBSR as a normal UE indicates its LCS notification capability to the AMF/CN during, e.g., a registration procedure.
   When the UE indicates its UE LCS notification capability, but the subscription data indicates that this UE is a MBSR, the AMF/CN discards the UE LCS notification capability. The AMF/CN does not invoke the UE LCS privacy check during the 5GC-MT-LR Procedure accordingly.
3) GMLC and subscription data (UE LCS privacy profile data)-centric optionl:
   In this option, a new type of UE LCS privacy profile data is utilized to determine whether to proceed with the UE LCS privacy check by the AMF/CN.
   Existing UE LCS privacy profile data has the information on the location service requestor only. In this option, a new type of privacy profile data e.g., Target UE type has the information on the UE LCS privacy check (e.g., UE/user is/is not involved for privacy check).
   The Target UE type in the UE LCS privacy profile data for MBSR includes the information that the UE does not require UE LCS privacy check.
   The GMLC obtains the UE LCS privacy profile data of the MBSR from the UDM during the 5GC-MT-LR Procedure as described in 3GPP TS 23.273 [4]. The GMLC includes the information that a UE LCS privacy check is not required for this UE to the location request message to the AMF.
   Based on the obtained information, the AMF/CN does not invoke the UE LCS privacy check during the 5GC-MT-LR Procedure accordingly.

The registration request procedure in clause 4.2 of 3GPP TS 23.502 [5] in Rel-17 can be used by the MBSR to access the 5GS. In addition, the location service procedure in clause 6.1.1 and 6.1.2 excepting for privacy check procedure in Rel-17 can be used for the location service.
4) GMLC and subscription data (capability information indicating that the wireless communication device is a particular type of device (e.g., mobile relay))-centric option2
   In this option, subscription data is utilized to determine whether to proceed with a UE LCS privacy check by the AMF/CN.
   The GMLC obtains the subscription data of the MBSR from the UDM during the 5GC-MT-LR Procedure as described in 3GPP TS 23.273 [4]. The GMLC includes the information that UE LCS privacy check is not required for this UE (e.g., MBSR) to the location request message to the AMF.
   Based on the obtained information, the AMF/CN does not invoke the UE LCS privacy check during the 5GC-MT-LR Procedure accordingly.

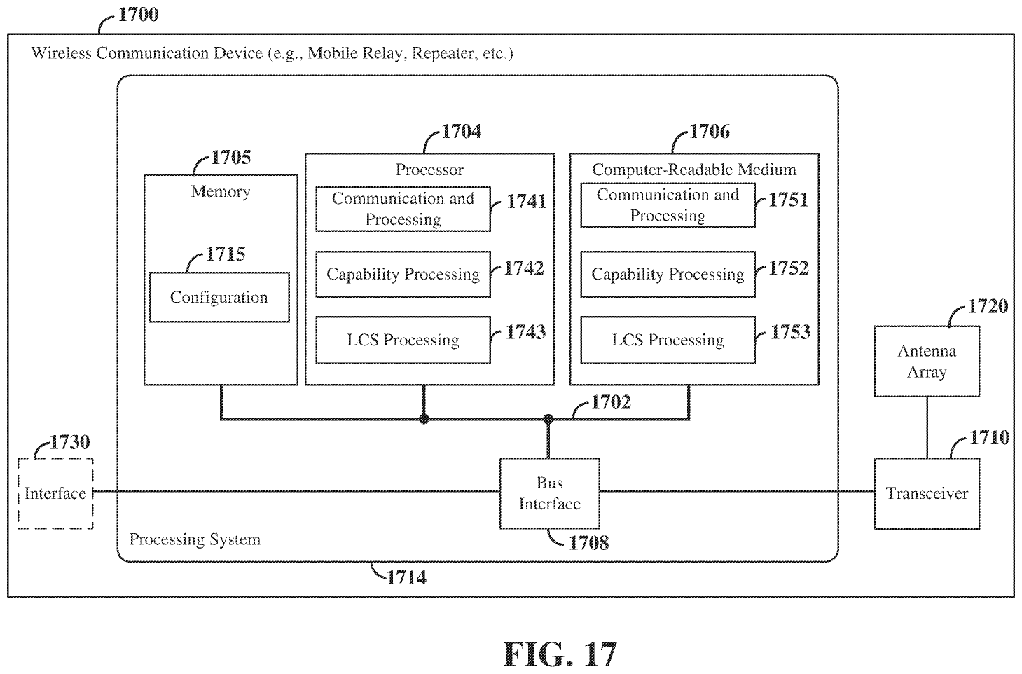

FIG. 17 is a block diagram illustrating an example of a hardware implementation for a wireless communication device 1700 employing a processing system 1714. In some examples, the wireless communication device 1700 may be a UE or scheduled entity configured to wirelessly communicate with a network node, base station, or scheduling entity, as discussed in any one or more of FIGS. 1-16. In some examples, the wireless communication device 1700 may correspond to any of the relay devices, UEs, sidelink devices, D2D devices, RUs, or scheduled entities shown in any of FIGS. 1, 2, 4-11, 13, 14, and 16. In some examples, the wireless communication device 1700 may correspond to any of the assisting nodes (e.g., repeaters) shown in any of FIGS. 1, 2, 4-10, 13, and 14.

In accordance with various aspects of the disclosure, an element, or any portion of an element, or any combination of elements may be implemented with the processing system 1714. The processing system 1714 may include one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1700 may be configured to perform any one or more of the functions described herein. That is, the processor 1704, as utilized in an wireless communication device 1700, may be used to implement any one or more of the processes and procedures described herein.

The processor 1704 may in some instances be implemented via a baseband or modem chip and in other implementations, the processor 1704 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702, a transceiver 1710 and an antenna array 1720 and between the bus 1702 and an interface 1730. The transceiver 1710 provides a communication interface or means for communicating with various other apparatus over a wireless transmission medium. The interface 1730 provides a communication interface or means of communicating with various other apparatuses and devices (e.g., other devices housed within the same apparatus as the wireless communication device or other external apparatuses) over an internal bus or external transmission medium, such as an Ethernet cable. Depending upon the nature of the wireless communication device 1700, the interface 1730 may include a user interface (e.g., keypad, display, speaker, microphone, joystick). Of course, such a user interface is optional, and may be omitted in some examples, such as an IoT device.

The processor 1704 is responsible for managing the bus 1702 and general processing, including the execution of software stored on the computer-readable medium 1706. The software, when executed by the processor 1704, causes the processing system 1714 to perform the various functions described below for any particular apparatus. The computer-readable medium 1706 and the memory 1705 may also be used for storing data that is manipulated by the processor 1704 when executing software. For example, the memory 1705 may store configuration information 1715 (e.g., capabilities information, subscription data, location services information, etc.) used by the processor 1704 for the location services-related operations described herein.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706.

The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

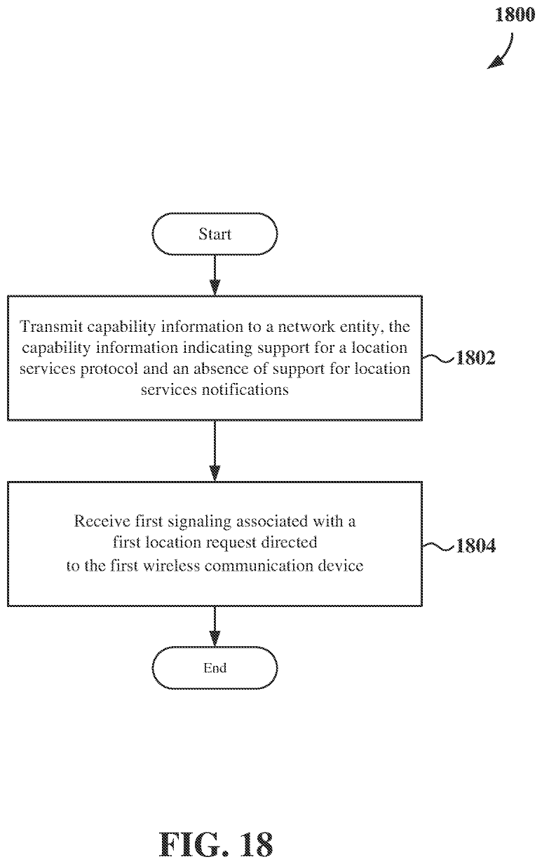

The wireless communication device 1700 may be configured to perform any one or more of the operations described herein (e.g., as described above in conjunction with FIGS. 1-16 and as described below in conjunction with FIG. 18). In some aspects of the disclosure, the processor 1704, as utilized in the wireless communication device 1700, may include circuitry configured for various functions.

The processor 1704 may include communication and processing circuitry 1741. The communication and processing circuitry 1741 may be configured to communicate with a scheduling entity, such as a gNB. The communication and processing circuitry 1741 may be configured to communicate with a network node (e.g., a base station) and one or more other wireless communication devices over a common carrier shared between a cellular (e.g., Uu) interface and a sidelink (e.g., PC5) interface. The communication and processing circuitry 1741 may be configured to communicate with one or more other wireless communication devices over a cellular (e.g., Uu) interface and/or a sidelink (e.g., PC5) interface. The communication and processing circuitry 1741 may include one or more hardware components that provide the physical structure that performs various processes related to wireless communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. In some examples, the communication and processing circuitry 1741 may include two or more transmit/receive chains (e.g., one chain to communicate with a base station and another chain to communicate with a sidelink device, or one chain to communicate with a first UE and another chain to communicate with another UE, etc.). The communication and processing circuitry 1741 may further be configured to execute communication and processing software 1751 included on the computer-readable medium 1706 to implement one or more functions described herein.

In examples where the wireless communication device 1700 is a relay wireless communication device, the communication and processing circuitry 1741 may forward data received from a first wireless communication device to a second wireless communication device in accordance with a forwarding configuration. For example, the communication and processing circuitry 1741 may forward data received from a first wireless communication device via a Uu link to a second wireless communication device via a Uu link. In addition, the communication and processing circuitry 1741 may forward data received from a third wireless communication device via a PC5 link to a fourth wireless communication device via a PC5 link.

In some implementations where the communication involves receiving information, the communication and processing circuitry 1741 may obtain information from a component of the wireless communication device 1700 (e.g., from the transceiver 1710 that receives the information via radio frequency signaling or some other type of signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 may receive one or more of signals, messages, SCIs, feedback, other information, or any combination thereof. In some examples, the communication and processing circuitry 1741 may receive information via one or more of a PSCCH, a PSSCH, a PSFCH, some other type of channel, or any combination thereof. In some examples, the communication and processing circuitry 1741 may include functionality for a means for receiving. In some examples, the communication and processing circuitry 1741 may include functionality for a means for decoding.

In some implementations where the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the transceiver 1710 (e.g., that transmits the information via radio frequency signaling or some other type of signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 may send one or more of signals, messages, SCIs, feedback, other information, or any combination thereof. In some examples, the communication and processing circuitry 1741 may send information via one or more of a PSCCH, a PS SCH, a PSFCH, some other type of channel, or any combination thereof. In some examples, the communication and processing circuitry 1741 may include functionality for a means for sending (e.g., a means for transmitting). In some examples, the communication and processing circuitry 1741 may include functionality for a means for encoding.

The processor 1704 may include capability processing circuitry 1742 configured to perform capability processing-related operations as discussed herein (e.g., one or more of the capability processing operations described in conjunction with FIGS. 12-16). The capability processing circuitry 1742 may be configured to execute capability processing software 1752 included on the computer-readable medium 1706 to implement one or more functions described herein.

The capability processing circuitry 1742 may include functionality for a means for transmitting capability information (e.g., as described at #1308 of FIG. 13 and/or #1408 of FIG. 14). For example, the capability processing circuitry 1742 may be configured to transmit LC S-related capability information (e.g., a 5GMM capability IE) to an AMF. As another example, the capability processing circuitry 1742 may be configured to transmit subscription data to an AMF. As a further example, the capability processing circuitry 1742 (e.g., including functionality for a means for setting) may be configured to set a field (e.g., of an IE) to a value indicating support for or the absence of support for a positioning protocol capability.

The processor 1704 may include LCS processing circuitry 1743 configured to perform LCS processing-related operations as discussed herein (e.g., one or more of the LCS processing operations described in conjunction with FIGS. 12-16). The LCS processing circuitry 1743 may be configured to execute LCS processing software 1753 included on the computer-readable medium 1706 to implement one or more functions described herein.

The LCS processing circuitry 1743 may include functionality for a means for receiving signaling. In some examples, the signaling may be associated with a first location request directed to the first wireless communication device (e.g., as described at Steps 7 and 8 and/or 12 of FIG. 7A). For example, the LCS processing circuitry 1743 may be configured to receive signaling from a gNB (e.g., for a positioning operation performed by an LWIF or some other network entity). As another example, the LCS processing circuitry 1743 may be configured to receive a message indicating the identity of an LCS client from an AMF. As a further example, the LCS processing circuitry 1743 may be configured to receive a location request from a network entity. As another example, the LCS processing circuitry 1743 may be configured to receive location service information from a wireless communication device.

The LCS processing circuitry 1743 may include functionality for a means for transmitting signaling for a positioning operation associated with the first wireless communication device (e.g., as described at Steps 7 and 8 and/or 12 of FIG. 7A). For example, the LCS processing circuitry 1743 may be configured to transmit signaling to a gNB for a positioning operation. As another example, the LCS processing circuitry 1743 (e.g., including functionality for a means for using) may be configured to use a location services protocol to send location services information to a network entity or to forward location services information to a wireless communication device. As a further example, the LCS processing circuitry 1743 may be configured to forward a location request to a wireless communication device.

FIG. 18 is a flow chart illustrating an example method 1800 for wireless communication in accordance with some aspects of the present disclosure. As described below, some or all illustrated features may be omitted in a particular implementation within the scope of the present disclosure, and some illustrated features may not be required for implementation of all examples. In some examples, the method 1800 may be carried out by the wireless communication device 1700 illustrated in FIG. 17. In some examples, the method 1800 may be carried out by any suitable apparatus or means for carrying out the functions or algorithm described below.

At block 1802, a first wireless communication device may transmit capability information to a network entity, the capability information indicating support for a location services protocol and an absence of support for location services notifications. For example, the capability processing circuitry 1742 together with the communication and processing circuitry 1741 and the transceiver 1710, shown and described above in connection with FIG. 17, may provide a means to transmit capability information to a network entity.

At block 1804, the first wireless communication device may receive first signaling associated with a first location request directed to the first wireless communication device. For example, the LCS processing circuitry 1743 together with the communication and processing circuitry 1741 and the transceiver 1710, shown and described above in connection with FIG. 17, may provide a means to receive first signaling associated with a first location request directed to the first wireless communication device.

In some examples, the first location request is not associated with a privacy check procedure. In some examples, the first wireless communication device may use the location services protocol to send location services information to the network entity. In some examples, the first location request may be a 3^{rd} Generation Partnership Project (3GPP) 5th Generation (5G) location services request.

In some examples, the capability information may include a 3^{rd} Generation Partnership Project (3GPP) 5th Generation (5G) mobility management (MM) capability information element (IE). In some examples, the 3GPP 5G MM capability IE may include a first field associated with a positioning protocol capability and a second field associated with a location services notifications capability. In some examples, the first wireless communication device may set the first field to a first value indicating the support for the positioning protocol capability. In some examples, the first wireless communication device may set the second field to a second value indicating the absence of support for the location services notifications capability.

In some examples, the first wireless communication device may receive a second location request from the network entity, the second location request being directed to a second wireless communication device. In some examples, the first wireless communication device may forward the second location request to the second wireless communication device. In some examples, the first wireless communication device may receive second location services information from the second wireless communication device after the second location request is forwarded. In some examples, the first wireless communication device may use the location services protocol to forward the second location services information to the network entity.

In some examples, the first wireless communication device is a mobile relay device. In some examples, the first wireless communication device is a vehicle mounted relay.

Referring again to FIG. 17, in one configuration, the wireless communication device 1700 includes means for transmitting capability information to a network entity, the capability information indicating support for a location services protocol and an absence of support for location services notifications, and means for receiving first signaling associated with a first location request directed to the first wireless communication device. In one aspect, the aforementioned means may be the processor 1704 shown in FIG. 17 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable medium 1706, or any other suitable apparatus or means described in any one or more of FIGS. 1, 2, 4-11, 13, 14, 16, and 17, and utilizing, for example, the methods and/or algorithms described herein in relation to FIG. 18.

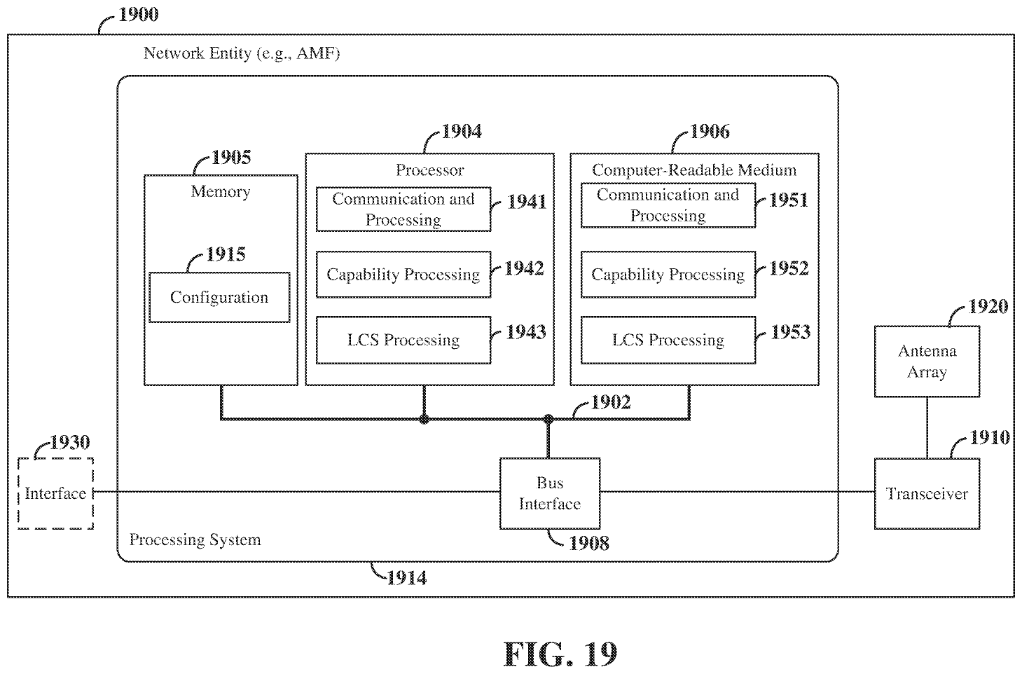

FIG. 19 is a conceptual diagram illustrating an example of a hardware implementation for a network entity 1900 employing a processing system 1914. In some implementations, the network entity 1900 may correspond to any of the network nodes shown in any of FIGS. 1, 2, 4-8, 13, 14, and 16.

In accordance with various aspects of the disclosure, an element, or any portion of an element, or any combination of elements may be implemented with the processing system 1914. The processing system may include one or more processors 1904. The processing system 1914 may be substantially the same as the processing system 1714 illustrated in FIG. 17, including a bus interface 1908, a bus 1902, memory 1905, a processor 1904, a computer-readable medium 1906, a transceiver 1910, and an antenna array 1920. The memory 1905 may store configuration information 1915 (e.g., capabilities information, subscription data, location services information, etc.) used by the processor 1904 in cooperation with the transceiver 1910 for the location services-related operations described herein. Furthermore, the network entity 1900 may include an interface 1930 (e.g., a network interface) that provides a means for communicating with at least one other apparatus within a core network and/or with at least one radio access network.

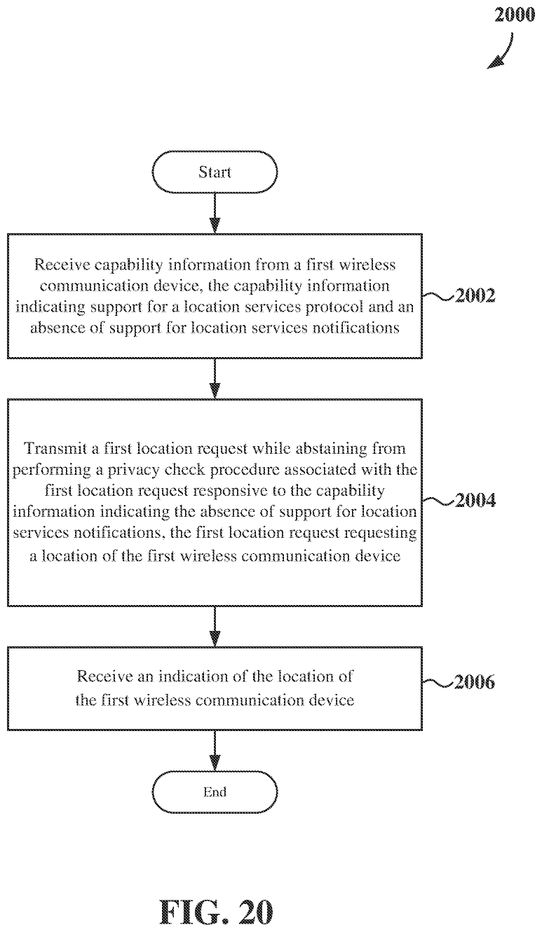

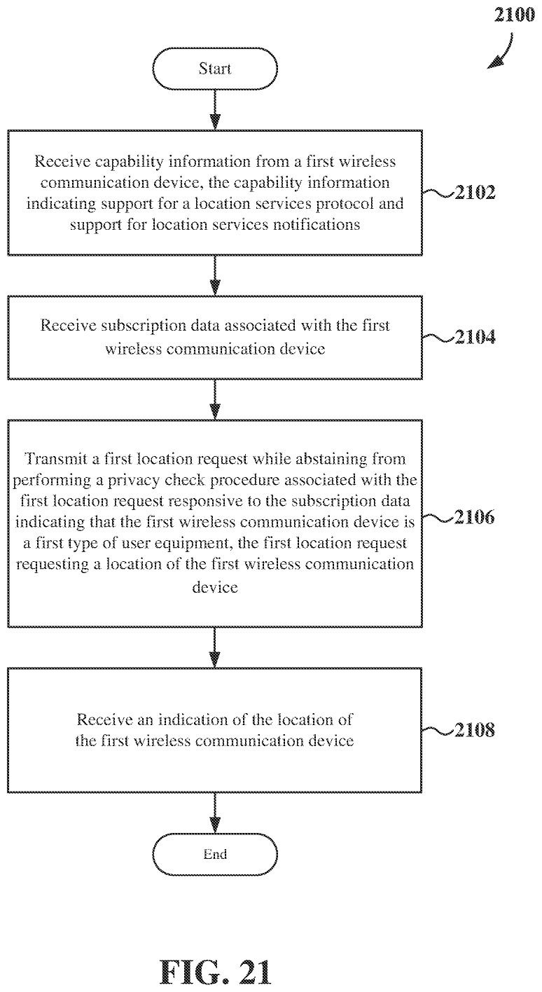

The network entity 1900 may be configured to perform any one or more of the operations described herein (e.g., as described above in conjunction with FIGS. 1-16 and as described below in conjunction with FIGS. 20 and 21). In some aspects of the disclosure, the processor 1904, as utilized in the network entity 1900, may include circuitry configured for various functions.

In some aspects of the disclosure, the processor 1904 may include communication and processing circuitry 1941. The communication and processing circuitry 1941 may include one or more hardware components that provide the physical structure that performs various processes related to communication (e.g., signal reception and/or signal transmission) as described herein. The communication and processing circuitry 1941 may further include one or more hardware components that provide the physical structure that performs various processes related to signal processing (e.g., processing a received signal and/or processing a signal for transmission) as described herein. The communication and processing circuitry 1941 may further be configured to execute communication and processing software 1951 included on the computer-readable medium 1906 to implement one or more functions described herein.

The communication and processing circuitry 1941 may be configured to communicate with one or more network entities and/or other communication devices. The communication and processing circuitry 1941 may include one or more hardware components that provide the physical structure that performs various processes related to wired or wireless communication (e.g., signal reception and/or signal transmission) as described herein. The communication and processing circuitry 1941 may further include one or more hardware components that provide the physical structure that performs various processes related to signal processing (e.g., processing a received signal and/or processing a signal for transmission) as described herein. In some examples, the communication and processing circuitry 1941 may include two or more transmit/receive chains. The communication and processing circuitry 1941 may further be configured to execute communication and processing software 1951 included on the computer-readable medium 1906 to implement one or more functions described herein.

In some implementations wherein the communication involves receiving information, the communication and processing circuitry 1941 may obtain information from a component of the network entity 1900 (e.g., from the transceiver 1910 that receives the information via radio frequency signaling or some other type of signaling suitable for the applicable communication medium), process (e.g., decode) the information, and output the processed information. For example, the communication and processing circuitry 1941 may output the information to another component of the processor 1904, to the memory 1905, or to the bus interface 1908. In some examples, the communication and processing circuitry 1941 may receive one or more of signals, messages, other information, or any combination thereof. In some examples, the communication and processing circuitry 1941 may receive information via one or more channels. In some examples, the communication and processing circuitry 1941 may include functionality for a means for receiving. In some examples, the communication and processing circuitry 1941 may include functionality for a means for decoding.

In some implementations wherein the communication involves sending (e.g., transmitting) information, the communication and processing circuitry 1941 may obtain information (e.g., from another component of the processor 1904, the memory 1905, or the bus interface 1908), process (e.g., encode) the information, and output the processed information. For example, the communication and processing circuitry 1941 may output the information to the transceiver 1910 (e.g., that transmits the information via radio frequency signaling or some other type of signaling suitable for the applicable communication medium). In some examples, the communication and processing circuitry 1941 may send one or more of signals, messages, other information, or any combination thereof. In some examples, the communication and processing circuitry 1941 may send information via one or more channels. In some examples, the communication and processing circuitry 1941 may include functionality for a means for sending (e.g., a means for transmitting). In some examples, the communication and processing circuitry 1941 may include functionality for a means for encoding.

The processor 1904 may include capability processing circuitry 1942 configured to perform capability processing-related operations as discussed herein (e.g., one or more of the capability processing operations described in conjunction with FIGS. 12-16). The capability processing circuitry 1942 may be configured to execute capability processing software 1952 included on the computer-readable medium 1906 to implement one or more functions described herein.

The capability processing circuitry 1942 may include functionality for a means for receiving capability information (e.g., as described at #1308 of FIG. 13 and/or #1408 of FIG. 14). For example, the capability processing circuitry 1942 may be configured to receive LCS-related capability information (e.g., a 5GMM capability IE) from a mobile relay.

The capability processing circuitry 1942 may include functionality for a means for receiving subscription data (e.g., as described at #1308 of FIG. 13 and/or #1408 of FIG. 14). For example, the capability processing circuitry 1942 may be configured to receive subscription data from a mobile relay during a registration procedure.

The capability processing circuitry 1942 may include functionality for a means for determining. For example, the capability processing circuitry 1942 may determine that a field (e.g., of an IE) is set to a value indicating support for or the absence of support for location services notifications capability. As another example, the capability processing circuitry 1942 may determine whether to perform the privacy check procedure for first wireless communication device without considering a field (e.g., of an IE). In some examples, the capability processing circuitry 1942 may set a field (e.g., of an IE) to a value indicating an absence of support for location services notifications.

The processor 1904 may include LCS processing circuitry 1943 configured to perform LCS processing-related operations as discussed herein (e.g., one or more of the LCS processing operations described in conjunction with FIGS. 12-16). The LCS processing circuitry 1943 may be configured to execute LCS processing software 1953 included on the computer-readable medium 1906 to implement one or more functions described herein.

The LCS processing circuitry 1943 may include functionality for a means for transmitting a location request (e.g., as described at Steps 10 and 11 of FIG. 7A and/or #1314 of FIG. 13 and/or #1416 of FIG. 14 and/or #1620 of FIG. 16). For example, the LCS processing circuitry 1943 may be configured to transmit a request for a location of a mobile relay to an LMF.

The LCS processing circuitry 1943 may include functionality for a means for receiving. In some examples, the LCS processing circuitry 1943 may receive an indication of a location (e.g., as described at Step 13 of FIG. 7A and/or #1314 of FIG. 13 and/or #1416 of FIG. 14 and/or #1620 of FIG. 16). For example, the LCS processing circuitry 1943 may be configured to receive location information from an LMF. As another example, the LCS processing circuitry 1943 may be configured to receive location service information from a wireless communication device. In some examples, the LCS processing circuitry 1943(e.g., including functionality for a means for using) may use a location services protocol to receive location services information.

The LCS processing circuitry 1943 may include functionality for a means for transmitting. For example, the LCS processing circuitry 1943 may be configured to transmit a location request to a wireless communication device.

FIG. 20 is a flow chart illustrating an example method 2000 for communication in accordance with some aspects of the present disclosure. As described below, some or all illustrated features may be omitted in a particular implementation within the scope of the present disclosure, and some illustrated features may not be required for implementation of all examples. In some examples, the method 2000 may be carried out by the network entity 1900 illustrated in FIG. 19. In some examples, the method 2000 may be carried out by any suitable apparatus or means for carrying out the functions or algorithm described below.

At block 2002, a network entity may receive capability information from a first wireless communication device, the capability information indicating support for a location services protocol and an absence of support for location services notifications. For example, the capability processing circuitry 1942 together with the communication and processing circuitry 1941 and the transceiver 1910, shown and described above in connection with FIG. 19, may provide a means to receive capability information from a first wireless communication device.

At block 2004, the network entity may transmit a first location request while abstaining from performing a privacy check procedure associated with the first location request responsive to the capability information indicating the absence of support for the location services notifications, the first location request requesting a location of the first wireless communication device. For example, the LCS processing circuitry 1943 together with the communication and processing circuitry 1941 and the transceiver 1910, shown and described above in connection with FIG. 19, may provide a means to transmit a first location request while abstaining from performing a privacy check procedure associated with the first location request responsive to the capability information indicating the absence of support for the location services notifications.

At block 2006, the network entity may receive an indication of the location of the first wireless communication device. For example, the LCS processing circuitry 1943 together with the communication and processing circuitry 1941 and the transceiver 1910, shown and described above in connection with FIG. 19, may provide a means to receive an indication of the location of the first wireless communication device.

In some examples, the network entity may use the location services protocol to receive location services information, the location services information including the indication of the location of the first wireless communication device. In some examples, the first location request may be a 3^{rd} Generation Partnership Project (3GPP) 5^{th} Generation (5G) location services request.

In some examples, the capability information may include a 3^{rd} Generation Partnership Project (3GPP) 5^{th} Generation (5G) mobility management (MM) capability information element (IE). In some examples, the 3GPP 5G MM capability IE may include a first field associated with a positioning protocol capability and a second field associated with a location services notification capability. In some examples, the network entity may determine that the first field is set to a first value indicating the support for the positioning protocol capability. In some examples, the network entity may determine that the second field is set to a second value indicating the absence of support for the location services notifications capability.

In some examples, the network entity may transmit a second location request to the first wireless communication device, the second location request requesting a location of a second wireless communication device. In some examples, the network entity may receive location services information from the first wireless communication device, the location services information including an indication of the location of the second wireless communication device. In some examples, the network entity may use the location services protocol to receive the location services information from the first wireless communication device.

In some examples, the first wireless communication device is a mobile relay device. In some examples, the first wireless communication device is a vehicle mounted relay.

FIG. 21 is a flow chart illustrating an example method 2100 for communication in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the network entity 1900 illustrated in FIG. 19. In some examples, the method 2100 may be carried out by any suitable apparatus or means for carrying out the functions or algorithm described below.

At block 2102, a network entity may receive capability information from a first wireless communication device, the capability information indicating support for a location services protocol and support for location services notifications. For example, the capability processing circuitry 1942 together with the communication and processing circuitry 1941 and the transceiver 1910, shown and described above in connection with FIG. 19, may provide a means to receive capability information from a first wireless communication device.

At block 2104, the network entity may receive subscription data associated with the first wireless communication device. For example, the capability processing circuitry 1942 together with the communication and processing circuitry 1941 and the transceiver 1910, shown and described above in connection with FIG. 19, may provide a means to receive subscription data associated with the first wireless communication device. At block 2106, the network entity may transmit a first location request while abstaining from performing a privacy check procedure associated with the first location request responsive to the subscription data indicating that the first wireless communication device is a first type of user equipment, the first location request requesting a location of the first wireless communication device. For example, the LCS processing circuitry 1943 together with the communication and processing circuitry 1941 and the transceiver 1910, shown and described above in connection with FIG. 19, may provide a means to transmit a first location request while abstaining from performing a privacy check procedure associated with the first location request responsive to the subscription data indicating that the first wireless communication device is a first type of user equipment.

At block 2108, the network entity may receive an indication of the location of the first wireless communication device. For example, the LCS processing circuitry 1943 together with the communication and processing circuitry 1941 and the transceiver 1910, shown and described above in connection with FIG. 19, may provide a means to receive an indication of the location of the first wireless communication device.

In some examples, the network entity may use the location services protocol to receive location services information, the location services information including the indication of the location of the first wireless communication device. In some examples, the first location request may be a 3^{rd} Generation Partnership Project (3GPP) 5^{th} Generation (5G) location services request.

In some examples, the capability information may include a 3^{rd} Generation Partnership Project (3GPP) 5^{th} Generation (5G) mobility management (MM) capability information element (IE). In some examples, the 3GPP 5G MM capability IE may include a first field associated with a positioning protocol capability and a second field associated with a location services notifications capability. In some examples, the network entity may set the second field to a value indicating an absence of support for the location services notifications capability. In some examples, the network entity may determine whether to perform the privacy check procedure for the first wireless communication device without considering the second field.

In some examples, the network entity may transmit a second location request to the first wireless communication device, the second location request requesting a location of a second wireless communication device. In some examples, the network entity may receive location services information from the first wireless communication device, the location services information including an indication of the location of the second wireless communication device. In some examples, the network entity may use the location services protocol to receive the location services information from the first wireless communication device.

In some examples, the first wireless communication device is a mobile relay device. In some examples, the first wireless communication device is a vehicle mounted relay.

In one configuration, the network entity 1900 includes means for receiving capability information from a first wireless communication device, the capability information indicating support for a location services protocol and an absence of support for location services notifications, means for transmitting a first location request while abstaining from performing a privacy check procedure associated with the first location request responsive to the capability information indicating the absence of support for the location services notifications, the first location request requesting a location of the first wireless communication device, and means for receiving an indication of the location of the first wireless communication device. In one aspect, the aforementioned means may be the processor 1904 shown in FIG. 19 configured to perform the functions recited by the aforementioned means (e.g., as discussed above). In another aspect, the aforementioned means may be a circuit or any apparatus configured to perform the functions recited by the aforementioned means.

In one configuration, the network entity 1900 includes means for receiving capability information from a first wireless communication device, the capability information indicating support for a location services protocol and support for location services notifications, means for receiving subscription data associated with the first wireless communication device, means for transmitting a first location request while abstaining from performing a privacy check procedure associated with the first location request responsive to the subscription data indicating that the first wireless communication device is a first type of user equipment, the first location request requesting a location of the first wireless communication device, and means for receiving an indication of the location of the first wireless communication device. In one aspect, the aforementioned means may be the processor 1904 shown in FIG. 19 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1904 is merely provided as an example, and other means for carrying out the described functions may be included within various aspects of the present disclosure, including but not limited to the instructions stored in the computer-readable medium 1906, or any other suitable apparatus or means described in any one or more of FIGS. 1, 2, 4-8, 13, 14, 16, and 19, and utilizing, for example, the methods and/or algorithms described herein in relation to FIGS. 20 and 21.

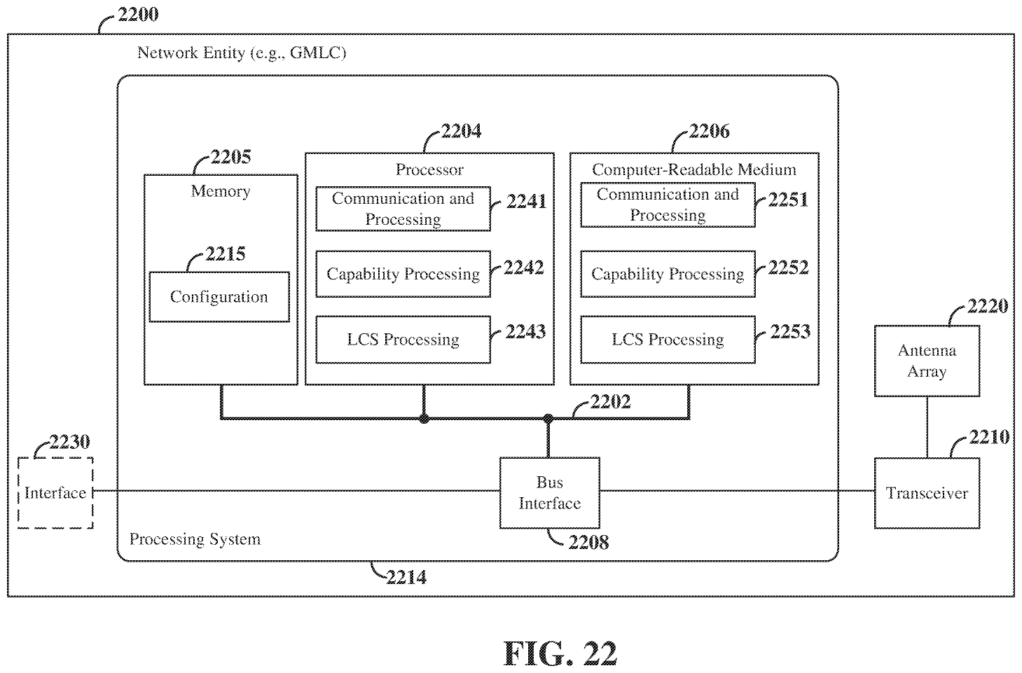

FIG. 22 is a conceptual diagram illustrating an example of a hardware implementation for a network entity 2200 employing a processing system 2214. In some implementations, the network entity 2200 may correspond to any of the network nodes shown in any of FIGS. 1, 2, 4-8, 13, 14, and 16.

In accordance with various aspects of the disclosure, an element, or any portion of an element, or any combination of elements may be implemented with the processing system 2214. The processing system may include one or more processors 2204. The processing system 2214 may be substantially the same as the processing system 1714 illustrated in FIG. 17, including a bus interface 2208, a bus 2202, memory 2205, a processor 2204, a computer-readable medium 2206, a transceiver 2210, and an antenna array 2220. The memory 2205 may store configuration information 2215 (e.g., capabilities information, subscription data, location services information, etc.) used by the processor 2204 in cooperation with the transceiver 2210 for the location services-related operations described herein. Furthermore, the network entity 2200 may include an interface 2230 (e.g., a network interface) that provides a means for communicating with at least one other apparatus within a core network and/or with at least one radio access network.

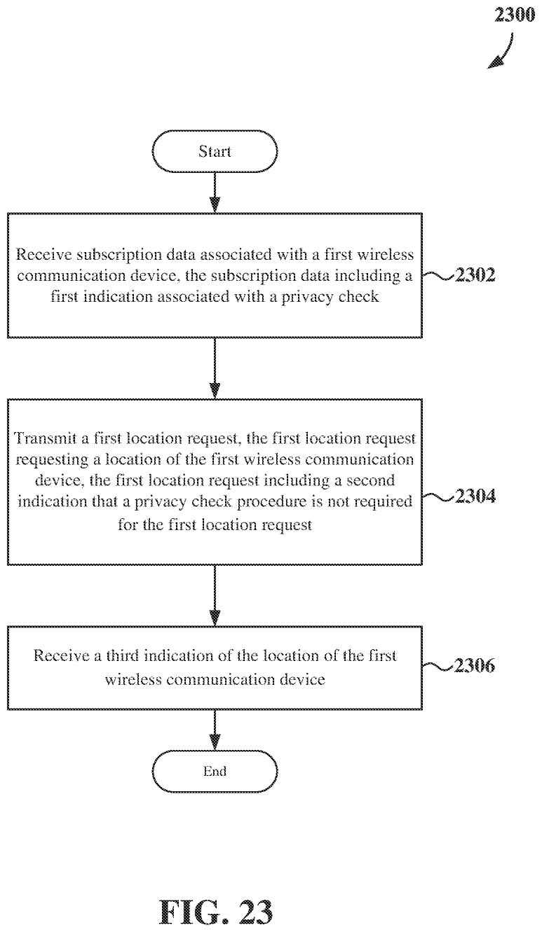

The network entity 2200 may be configured to perform any one or more of the operations described herein (e.g., as described above in conjunction with FIGS. 1-16 and as described below in conjunction with FIG. 23). In some aspects of the disclosure, the processor 2204, as utilized in the network entity 2200, may include circuitry configured for various functions.

In some aspects of the disclosure, the processor 2204 may include communication and processing circuitry 2241. The communication and processing circuitry 2241 may include one or more hardware components that provide the physical structure that performs various processes related to communication (e.g., signal reception and/or signal transmission) as described herein. The communication and processing circuitry 2241 may further include one or more hardware components that provide the physical structure that performs various processes related to signal processing (e.g., processing a received signal and/or processing a signal for transmission) as described herein. The communication and processing circuitry 2241 may further be configured to execute communication and processing software 2251 included on the computer-readable medium 2206 to implement one or more functions described herein.

The communication and processing circuitry 2241 may be configured to communicate with one or more network entities and/or other communication devices. The communication and processing circuitry 2241 may include one or more hardware components that provide the physical structure that performs various processes related to wired or wireless communication (e.g., signal reception and/or signal transmission) as described herein. The communication and processing circuitry 2241 may further include one or more hardware components that provide the physical structure that performs various processes related to signal processing (e.g., processing a received signal and/or processing a signal for transmission) as described herein. In some examples, the communication and processing circuitry 2241 may include two or more transmit/receive chains. The communication and processing circuitry 2241 may further be configured to execute communication and processing software 2251 included on the computer-readable medium 2206 to implement one or more functions described herein.

In some implementations wherein the communication involves receiving information, the communication and processing circuitry 2241 may obtain information from a component of the network entity 2200 (e.g., from the transceiver 2210 that receives the information via radio frequency signaling or some other type of signaling suitable for the applicable communication medium), process (e.g., decode) the information, and output the processed information. For example, the communication and processing circuitry 2241 may output the information to another component of the processor 2204, to the memory 2205, or to the bus interface 2208. In some examples, the communication and processing circuitry 2241 may receive one or more of signals, messages, other information, or any combination thereof. In some examples, the communication and processing circuitry 2241 may receive information via one or more channels. In some examples, the communication and processing circuitry 2241 may include functionality for a means for receiving. In some examples, the communication and processing circuitry 2241 may include functionality for a means for decoding.

In some implementations wherein the communication involves sending (e.g., transmitting) information, the communication and processing circuitry 2241 may obtain information (e.g., from another component of the processor 2204, the memory 2205, or the bus interface 2208), process (e.g., encode) the information, and output the processed information. For example, the communication and processing circuitry 2241 may output the information to the transceiver 2210 (e.g., that transmits the information via radio frequency signaling or some other type of signaling suitable for the applicable communication medium). In some examples, the communication and processing circuitry 2241 may send one or more of signals, messages, other information, or any combination thereof. In some examples, the communication and processing circuitry 2241 may send information via one or more channels. In some examples, the communication and processing circuitry 2241 may include functionality for a means for sending (e.g., a means for transmitting). In some examples, the communication and processing circuitry 2241 may include functionality for a means for encoding.

The processor 2204 may include capability processing circuitry 2242 configured to perform capability processing-related operations as discussed herein (e.g., one or more of the capability processing operations described in conjunction with FIGS. 12-16). The capability processing circuitry 2242 may be configured to execute capability processing software 2252 included on the computer-readable medium 2206 to implement one or more functions described herein.

The capability processing circuitry 2242 may include functionality for a means for receiving. In some examples, the capability processing circuitry 2242 may receive subscription data (e.g., as described at #1612 of FIG. 16). For example, the capability processing circuitry 2242 may be configured to receive subscription data of a mobile relay from a UDM.

The processor 2204 may include LCS processing circuitry 2243 configured to perform LCS processing-related operations as discussed herein (e.g., one or more of the LCS processing operations described in conjunction with FIGS. 12-16). The LCS processing circuitry 2243 may be configured to execute LCS processing software 2253 included on the computer-readable medium 2206 to implement one or more functions described herein.

The LCS processing circuitry 2243 may include functionality for a means for transmitting. In some examples, the LCS processing circuitry 2243 may transmit a location request (e.g., as described at #1616 of FIG. 16). For example, the LCS processing circuitry 2243 may be configured to transmit a request for a location of a mobile relay to an AMF.

The LCS processing circuitry 2243 may include functionality for a means for generating. For example, the LCS processing circuitry 2243 may be configured to generate a location request including an indication that a privacy check procedure is not required.

The LCS processing circuitry 2243 may include functionality for a means for receiving. In some examples, the LCS processing circuitry 2243 may receive an indication of a location (e.g., as described at #1622 of FIG. 16). For example, the LCS processing circuitry 2243 may be configured to receive location information from an AMF. As another example, the LCS processing circuitry 2243 may be configured to receive location services information. As a further example, the LCS processing circuitry 2243 (e.g., including functionality for a means for using) may be configured to use a location services protocol to receive location services information.

FIG. 23 is a flow chart illustrating an example method 2300 for communication in accordance with some aspects of the present disclosure. As described below, some or all illustrated features may be omitted in a particular implementation within the scope of the present disclosure, and some illustrated features may not be required for implementation of all examples. In some examples, the method 2300 may be carried out by the network entity 2200 illustrated in FIG. 22. In some examples, the method 2300 may be carried out by any suitable apparatus or means for carrying out the functions or algorithm described below.

At block 2302, a network entity may receive subscription data associated with a first wireless communication device, the subscription data including a first indication associated with a privacy check. For example, the capability processing circuitry 2242 together with the communication and processing circuitry 2241 and the transceiver 2210, shown and described above in connection with FIG. 22, may provide a means to receive subscription data associated with a first wireless communication device.

At block 2304, the network entity may transmit a first location request, the first location request requesting a location of the first wireless communication device, the first location request including a second indication that a privacy check procedure is not required for the first location request. For example, the LCS processing circuitry 2243 together with the communication and processing circuitry 2241 and the transceiver 2210, shown and described above in connection with FIG. 22, may provide a means to transmit a first location request.

At block 2306, the network entity may receive a third indication of the location of the first wireless communication device. For example, the LCS processing circuitry 2243 together with the communication and processing circuitry 2241 and the transceiver 2210, shown and described above in connection with FIG. 22, may provide a means to receive a third indication of the location of the first wireless communication device.

In some examples, the first indication indicates that a user is not involved with a location services privacy check. In some examples, the network entity may generate the first location request including the second indication in response to the subscription data including the first indication. In some examples, the first location request may be a 3 rd Generation Partnership Project (3GPP) 5^{th} Generation (5G) location services request.

In some examples, the first indication specifies whether the first wireless communication device is a specific type of wireless communication device. In some examples, the first wireless communication device is a mobile relay device. In some examples, the first wireless communication device is a vehicle mounted relay.

In some examples, the first indication indicates whether the first wireless communication device is allowed for mobile relay operation. In some examples, the first indication indicates whether the first wireless communication device is allowed for vehicle mounted relay (VMR) operation.

In some examples, the network entity may transmit a second location request, the second location request requesting a location of a second wireless communication device connected to the first wireless communication device. In some examples, the network entity may receive location services information, the location services information including a fourth indication of the location of the second wireless communication device. In some examples, the network entity may use a location services protocol to receive the location services information from the first wireless communication device.

In one configuration, the network entity 2200 includes means for receiving subscription data associated with a first wireless communication device, the subscription data including a first indication that a user is not involved with a location services privacy check, means for transmitting a first location request, the first location request requesting a location of the first wireless communication device, the first location request including a second indication that a privacy check procedure is not required for the first location request, and means for receiving a third indication of the location of the first wireless communication device. In one aspect, the aforementioned means may be the processor 2204 shown in FIG. 22 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2204 is merely provided as an example, and other means for carrying out the described functions may be included within various aspects of the present disclosure, including but not limited to the instructions stored in the computer-readable medium 2206, or any other suitable apparatus or means described in any one or more of FIGS. 1, 2, 4-8, 13, 14, 16, and 22, and utilizing, for example, the methods and/or algorithms described herein in relation to FIG. 23.

The methods shown in FIGS. 18, 20, 21, and 23 may include additional aspects, such as any single aspect or any combination of aspects described below and/or in connection with one or more other processes described elsewhere herein. The following provides an overview of several aspects of the present disclosure.
Aspect 1: A method for wireless communication at a user equipment, the method comprising: transmitting capability information to a network entity, the capability information indicating support for a location services protocol and an absence of support for location services notifications; and receiving first signaling associated with a first location request directed to the first wireless communication device.
Aspect 2: The method of aspect 1, wherein the first location request is not associated with a privacy check procedure.
Aspect 3: The method of aspect 1 or 2, further comprising: using the location services protocol to send location services information to the network entity, the location services information including the indication of the location of the first wireless communication device.
Aspect 4: The method of any of aspects 1 through 3, wherein the first location request comprises a 3^{rd} Generation Partnership Project (3GPP) 5^{th} Generation (5G) location services request.
Aspect 5: The method of any of aspects 1 through 4, wherein the capability information comprises a 3^{rd} Generation Partnership Project (3GPP) 5^{th} Generation (5G) mobility management (MM) capability information element (IE).
Aspect 6: The method of aspect 5, wherein: the 3GPP 5G MM capability IE comprises a first field associated with a positioning protocol capability and a second field associated with a location services notifications capability; the method further comprises setting the first field to a first value indicating the support for the positioning protocol capability; and the method further comprises setting the second field to a second value indicating the absence of support for the location services notifications capability.
Aspect 7: The method of any of aspects 1 through 6, further comprising: receiving a second location request from the network entity, the second location request being directed to a second wireless communication device; forwarding the second location request to the second wireless communication device; receiving second location services information from the second wireless communication device after the second location request is forwarded; and using the location services protocol to forward the second location services information to the network entity.
Aspect 8: The method of any of aspects 1 through 7, wherein the first wireless communication device is a mobile relay device.
Aspect 9: The method of any of aspects 1 through 7, wherein the first wireless communication device is a vehicle mounted relay.
Aspect 11: A method for communication at a network entity, the method comprising: receiving capability information from a first wireless communication device, the capability information indicating support for a location services protocol and an absence of support for location services notifications; transmitting a first location request while abstaining from performing a privacy check procedure associated with the first location request responsive to the capability information indicating the absence of support for the location services notifications, the first location request requesting a location of the first wireless communication device; and receiving an indication of the location of the first wireless communication device.
Aspect 12: The method of aspect 11, further comprising: using the location services protocol to receive location services information, the location services information including the indication of the location of the first wireless communication device.
Aspect 13: The method of any of aspects 11 through 12, wherein the first location request comprises a 3^{rd} Generation Partnership Project (3GPP) 5^{th} Generation (5G) location services request.
Aspect 14: The method of any of aspects 11 through 13, wherein the capability information comprises a 3^{rd} Generation Partnership Project (3GPP) 5t h Generation (5G) mobility management (MM) capability information element (IE).
Aspect 15: The method of aspect 14, wherein: the 3GPP 5G MM capability IE comprises a first field associated with a positioning protocol capability and a second field associated with a location services notifications capability; the method further comprises determining that the first field is set to a first value indicating the support for the positioning protocol capability; and the method further comprises determining that the second field is set to a second value indicating the absence of support for the location services notifications capability.
Aspect 16: The method of any of aspects 11 and 13 through 15, further comprising: transmitting a second location request to the first wireless communication device, the second location request requesting a location of a second wireless communication device; and receiving location services information from the first wireless communication device, the location services information including an indication of the location of the second wireless communication device.
Aspect 17: The method of aspect 16, further comprising: using the location services protocol to receive the location services information from the first wireless communication device.
Aspect 18: The method of any of aspects 11 through 17, wherein the first wireless communication device is a mobile relay device.
Aspect 19: The method of any of aspects 11 through 17, wherein the first wireless communication device is a vehicle mounted relay.
Aspect 21: A method for communication at a network entity, the method comprising: receiving capability information from a first wireless communication device, the capability information indicating support for a location services protocol and support for location services notifications; receiving subscription data associated with the first wireless communication device; transmitting a first location request while abstaining from performing a privacy check procedure associated with the first location request responsive to the subscription data indicating that the first wireless communication device comprises a first type of user equipment, the first location request requesting a location of the first wireless communication device; and receiving an indication of the location of the first wireless communication device.
Aspect 22: The method of aspect 21, further comprising: using the location services protocol to receive location services information, the location services information including the indication of the location of the first wireless communication device.
Aspect 23: The method of any of aspects 21 through 22, wherein the first location request comprises a 3^{rd} Generation Partnership Project (3GPP) 5^{th} Generation (5G) location services request.
Aspect 24: The method of any of aspects 21 through 23, wherein the capability information comprises a 3^{rd} Generation Partnership Project (3GPP) 5^{th} Generation (5G) mobility management (MM) capability information element (IE).
Aspect 25: The method of aspect 24, wherein the 3GPP 5G MM capability IE comprises a first field associated with a positioning protocol capability and a second field associated with a location services notifications capability.
Aspect 26: The method of aspect 25, further comprising: setting the second field to a value indicating an absence of support for the location services notifications capability.
Aspect 27: The method of aspect 25, further comprising: determining whether to perform the privacy check procedure for the first wireless communication device without considering the second field.
Aspect 28: The method of any of aspects 21 through 27, further comprising: transmitting a second location request to the first wireless communication device, the second location request requesting a location of a second wireless communication device; and receiving location services information from the first wireless communication device, the location services information including an indication of the location of the second wireless communication device.
Aspect 29: The method of aspect 28, further comprising: using the location services protocol to receive the location services information from the first wireless communication device.
Aspect 30: A method for communication at a network entity, the method comprising: receiving subscription data associated with a first wireless communication device, the subscription data including a first indication associated with a privacy check; transmitting a first location request, the first location request requesting a location of the first wireless communication device, the first location request including a second indication that a privacy check procedure is not required for the first location request; and receiving a third indication of the location of the first wireless communication device.
Aspect 31: The method of aspect 30, wherein the first indication indicates that a user is not involved with a location services privacy check.
Aspect 32: The method of any of aspects 30 through 31, further comprising: generating the first location request including the second indication in response to the subscription data including the first indication
Aspect 33: The method of any of aspects 30 through 32, wherein the first indication specifies whether the first wireless communication device is a specific type of wireless communication device.
Aspect 34: The method of any of aspects 30 through 33, wherein the first wireless communication device is a mobile relay device.
Aspect 35: The method of any of aspects 30 through 34, further comprising: transmitting a second location request, the second location request requesting a location of a second wireless communication device connected to the first wireless communication device; and receiving location services information, the location services information including a fourth indication of the location of the second wireless communication device.
Aspect 36: The method of aspect 35, using a location services protocol to receive the location services information from the first wireless communication device.
Aspect 37: The method of any of aspects 30 and 32 through 36, wherein the first indication indicates whether the first wireless communication device is allowed for mobile relay operation.
Aspect 38: The method of any of aspects 30 and 32 through 36, wherein the first indication indicates whether the first wireless communication device is allowed for vehicle mounted relay (VMR) operation.
Aspect 39: The method of any of aspects 30 through 38, wherein the first location request comprises a 3^{rd} Generation Partnership Project (3GPP) 5^{th} Generation (5G) location services request.
Aspect 40: The method of any of aspects 30 through 39, wherein the first wireless communication device is a vehicle mounted relay.
Aspect 41: A wireless communication device comprising: a transceiver, a memory, and a processor coupled to the transceiver and the memory, wherein the processor is configured to perform any of aspects 1 through 9.
Aspect 42: An apparatus configured for wireless communication comprising at least one means for performing any of aspects 1 through 9.
Aspect 43: A non-transitory computer-readable medium storing computer-executable code, comprising code for causing an apparatus to perform any of aspects 1 through 9.
Aspect 44: A network entity comprising: a communication interface, and a processor coupled to the communication interface, wherein the processor is configured to perform any of aspects 11 through 19.
Aspect 45: An apparatus configured for wireless communication comprising at least one means for performing any of aspects 11 through 19.
Aspect 46: A non-transitory computer-readable medium storing computer-executable code, comprising code for causing an apparatus to perform any of aspects 11 through 19.
Aspect 47: A network entity comprising: a communication interface, and a processor coupled to the communication interface, wherein the processor is configured to perform any of aspects 21 through 29.
Aspect 48: An apparatus configured for wireless communication comprising at least one means for performing any of aspects 21 through 29.

Aspect 49: A non-transitory computer-readable medium storing computer-executable code, comprising code for causing an apparatus to perform any of aspects 21 through 29.
Aspect 50: A network entity comprising: a communication interface, and a processor coupled to the communication interface, wherein the processor is configured to perform any of aspects 30 through 40.
Aspect 51: An apparatus configured for wireless communication comprising at least one means for performing any of aspects 30 through 40.
Aspect 52: A non-transitory computer-readable medium storing computer-executable code, comprising code for causing an apparatus to perform any of aspects 30 through 40.

Several aspects of a wireless communication network have been presented with reference to an example implementation. As those skilled in the art will readily appreciate, various aspects described throughout this disclosure may be extended to other telecommunication systems, network architectures and communication standards. By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-23 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4-11, 13, 14, 16, 17, 19, and 22 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first wireless communication device, comprising:
a transceiver; and
a processor coupled to the transceiver, wherein the processor is configured to:
transmit capability information to a network entity via the transceiver, the capability information indicating support for a location services protocol and an absence of support for location services notifications; and
receive, via the transceiver, first signaling associated with a first location request directed to the first wireless communication device.

2. The first wireless communication device of claim 1, wherein the first location request is not associated with a privacy check procedure.

3. The first wireless communication device of claim 1, wherein the processor is further configured to:
use the location services protocol to send location services information to the network entity.

4. The first wireless communication device of claim 1, wherein the first location request comprises a 3^{rd} Generation Partnership Project (3GPP) 5^{th} Generation (5G) location services request.

5. The first wireless communication device of claim 1, wherein the capability information comprises a 3^{rd} Generation Partnership Project (3GPP) 5 th Generation (5G) mobility management (MM) capability information element (IE).

6. The first wireless communication device of claim 5, wherein:
the 3GPP 5G MINI capability IE comprises a first field associated with a positioning protocol capability and a second field associated with a location services notifications capability;
the processor is further configured to set the first field to a first value indicating the support for the positioning protocol capability; and
the processor is further configured to set the second field to a second value indicating the absence of support for the location services notifications capability.

7. The first wireless communication device of claim 1, wherein the processor is further configured to:
receive a second location request from the network entity via the transceiver, the second location request being directed to a second wireless communication device;
forward the second location request to the second wireless communication device via the transceiver;
receive second location services information from the second wireless communication device via the transceiver after the second location request is forwarded; and
use the location services protocol to forward the second location services information to the network entity.

8. The first wireless communication device of claim 1, wherein the first wireless communication device is a mobile relay device.

9. The first wireless communication device of claim 1, wherein the first wireless communication device is a vehicle mounted relay.

10. A method for wireless communication at a first wireless communication device, comprising:
transmitting capability information to a network entity, the capability information indicating support for a location services protocol and an absence of support for location services notifications; and
receiving first signaling associated with a first location request directed to the first wireless communication device.

11. A network entity, comprising:
a communication interface; and
a processor coupled to the communication interface, wherein the processor is configured to:
receive capability information from a first wireless communication device via the communication interface, the capability information indicating support for a location services protocol and an absence of support for location services notifications;
transmit a first location request via the communication interface while abstaining from performing a privacy check procedure associated with the first location request responsive to the capability information indicating the absence of support for the location services notifications, the first location request requesting a location of the first wireless communication device; and
receive an indication of the location of the first wireless communication device via the communication interface.

12. The network entity of claim 11, wherein the processor is further configured to:
use the location services protocol to receive location services information, the location services information including the indication of the location of the first wireless communication device.

13. The network entity of claim 11, wherein the first location request comprises a 3^{rd} Generation Partnership Project (3GPP) 5^{th} Generation (5G) location services request.

14. The network entity of claim 11, wherein the capability information comprises a 3^{rd} Generation Partnership Project (3GPP) 5^{th} Generation (5G) mobility management (MM) capability information element (IE).

15. The network entity of claim 14, wherein:
the 3GPP 5G MINI capability IE comprises a first field associated with a positioning protocol capability and a second field associated with a location services notifications capability;
the processor is further configured to determine that the first field is set to a first value indicating the support for the positioning protocol capability; and
the processor is further configured to determine that the second field is set to a second value indicating the absence of support for the location services notifications capability.

16. The network entity of claim 11, wherein the processor is further configured to:
transmit a second location request to the first wireless communication device via the communication interface, the second location request requesting a location of a second wireless communication device; and
receive location services information from the first wireless communication device via the communication interface, the location services information including an indication of the location of the second wireless communication device.

17. The network entity of claim 16, wherein the processor is further configured to:
use the location services protocol to receive the location services information from the first wireless communication device.

18. The network entity of claim 11, wherein the first wireless communication device is a mobile relay device.

19. The network entity of claim 11, wherein the first wireless communication device is a vehicle mounted relay.

20. A network entity, comprising:
a communication interface; and
a processor coupled to the communication interface, wherein the processor is configured to:
receive subscription data associated with a first wireless communication device via the communication interface, the subscription data including a first indication associated with a privacy check;
transmit a first location request via the communication interface, the first location request requesting a location of the first wireless communication device, the first location request including a second indication that a privacy check procedure is not required for the first location request; and
receive a third indication of the location of the first wireless communication device via the communication interface.

21. The network entity of claim 20, wherein the first indication indicates that a user is not involved with a location services privacy check.

22. The network entity of claim 20, wherein the processor is further configured to:
generate the first location request including the second indication in response to the subscription data including the first indication.

23. The network entity of claim 20, wherein the first indication specifies whether the first wireless communication device is a specific type of wireless communication device.

24. The network entity of claim 20, wherein the first wireless communication device is a mobile relay device.

25. The network entity of claim 20, wherein the processor is further configured to:
transmit a second location request via the communication interface, the second location request requesting a location of a second wireless communication device connected to the first wireless communication device; and
receive location services information via the communication interface, the location services information including a fourth indication of the location of the second wireless communication device.

26. The network entity of claim 25, wherein the processor is further configured to:
use a location services protocol to receive the location services information from the first wireless communication device.

27. The network entity of claim 20, wherein the first indication indicates whether the first wireless communication device is allowed for mobile relay operation.

28. The network entity of claim 20, wherein the first indication indicates whether the first wireless communication device is allowed for vehicle mounted relay (VMR) operation.

29. The network entity of claim 20, wherein the first location request comprises a 3^{rd} Generation Partnership Project (3GPP) 5^{th} Generation (5G) location services request.

30. The network entity of claim 20, wherein the first wireless communication device is a vehicle mounted relay.
